(19) United States
(12) Patent Application Publication
(10) Pub. No.: US 2023/0011045 A1
(43) Pub. Date: Jan. 12, 2023

(54) LCMS WITH ESI SOURCE FOR ENHANCED SENSITIVITY OF COMPOUNDS

(71) Applicant: PerkinElmer Health Sciences, Inc., Waltham, MA (US)

(72) Inventor: Avinash Dalmia, Hamden, CT (US)

(21) Appl. No.: 17/371,253

(22) Filed: Jul. 9, 2021

(51) Int. Cl. G01N 30/74

(52) U.S. Cl. CPC G01N 30/74; G01N 2030/027

(57) ABSTRACT

This disclosure provides liquid chromatography tandem mass spectrometer (LC-MS/MS) methods and systems for detecting low levels of pesticides in a test sample. In the disclosed methods and systems, an ammonium salt is added to a mobile phase added to a liquid chromatography column or to the eluant from a liquid chromatography column. This addition improves the signal for certain pesticides by a factor of from 2 to 20, improving their detection limits in a variety of test samples.

### TECHNICAL FIELD

This disclosure relates generally to systems and methods for detecting and/or quantifying pesticides using mass spectrometry.

### BACKGROUND

Liquid chromatography tandem mass spectrometer (LC-MS/MS) methods can be used to detect pesticides in a variety of test samples, including in cannabis and food matrices. It is common practice when using an electrospray ionization source (ESI) in such methods to add certain volatile chemicals or additives to the mobile phase or to introduce them post-column, prior to the ESI interface, to influence analyte ionization and improve the analyte signal.

The most commonly used additives are volatile acids (formic, acetic, and trifluoroacetic acid) and salts (ammonium formate and ammonium acetate). The acidic additives are used to enhance ionization or signal of analytes in positive ion mode by protonating them. The neutral salts are added to the mobile phase either to improve ionization efficiency of molecules that have low proton affinity in positive ion mode, by forming ammonia adducts, or to form ions in negative ion mode by deprotonation or adduct formation.

### SUMMARY OF THE INVENTION

The ionization efficiency of certain pesticides is quite low with the use of the most commonly used additives, making it difficult to measure very low levels of these pesticides in cannabis, food, water, and other matrices. Thus, it is an object of this invention to provide improved systems and methods for detecting and quantifying such pesticides in test samples in order to comply with rigorous and stringent testing regulations in various U.S. states and countries, such as, but not limited to, Florida, California, and Canada.

In accordance with some embodiments, the present disclosure includes a liquid chromatography (LC) column comprising a mobile phase composition, wherein the mobile phase composition comprises a first mobile phase (e.g., water), a second mobile phase (e.g., methanol), and from 0.1 mM to 100 mM of an ammonium salt selected from the group consisting of ammonium hydroxide, ammonium bicarbonate, and ammonium fluoride.

For example, in at least some embodiments, the first mobile phase independently comprises a first concentration of the ammonium salt of from 0 mM to 100 mM and the second mobile phase independently comprises a second concentration of the ammonium salt of from 0 mM to 100 mM, provided that at least one of the first and second concentrations is greater than 0 mM.

In accordance with some embodiments, the LC column comprises a test sample, such as a botanical test sample, an environmental sample, or a clinical sample and/or a marijuana or hemp product (e.g., flowers, concentrates, edibles, topicals, smokables). In at least some embodiments, the test sample comprises a pesticide (e.g., chlordane, chlorfenapyr, cyfluthrin, cyhalothrin, cypermethrin, endosulfan 1, endosulfan 2).

In accordance with some embodiments, the present disclosure includes an LC separation system, comprising (a) an LC column; (b) a first mobile phase (e.g., water) comprising a first concentration of an ammonium salt of from 0 mM to 100 mM; and (c) a second mobile phase (e.g., methanol) independently comprising a second concentration of from 0 mM to 100 mM of the ammonium salt, provided that at least one of the first and second concentrations is greater than 0 mM, wherein the ammonium salt is selected from the group consisting of ammonium hydroxide, ammonium bicarbonate, and ammonium fluoride.

In accordance with some embodiments, the present disclosure includes a liquid chromatography tandem mass spectrometer (LC-MS/MS) system, comprising (a) a liquid chromatography (LC) column or a LC separation system according to any one of the embodiments described above; and (b) a triple quadrupole mass spectrometer. In at least some embodiments, the triple quadrupole mass spectrometer is configured to detect an MRM transition selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524.00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).

In accordance with some embodiments, the present disclosure includes method of detecting a pesticide in a test sample, comprising (a) processing a test sample using a liquid chromatography (LC) column or a LC separation system according to any one of the embodiments described above to provide an LC column eluant; and (b) analyzing the LC column eluant for the presence of the pesticide using a triple quadrupole mass spectrometer. In at least some embodiments, the test sample comprises a pesticide (e.g., of chlordane, chlorfenapyr, cyfluthrin, cyhalothrin, cypermethrin, endosulfan 1, endosulfan 2). In at least some embodiments, the test sample is a botanical test sample, an aqueous sample, or a clinical sample and/or an extract of a marijuana or hemp product (e.g., flowers, concentrates, edibles, topicals, smokables). In at least some embodiments, the triple quadrupole mass spectrometer is configured to detect an MRM transition selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524.00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).

In accordance with some embodiments, the present disclosure includes a method of detecting a pesticide in a test sample, comprising (a) processing a test sample using a liquid chromatography column to produce a first liquid chromatography (LC) column eluant; (b) adding to the first LC column eluant an ammonium salt selected from the group consisting of ammonium hydroxide, ammonium bicarbonate, and ammonium fluoride to form a second LC column eluant in which the concentration of the ammonium salt is from 0.1 mM to 100 mM; and (c) analyzing the second LC column eluant for the presence of the pesticide using a triple quadrupole mass spectrometer. In at least some embodiments, the test sample comprises a pesticide (e.g., of chlordane, chlorfenapyr, cyfluthrin, cyhalothrin, cypermethrin, endosulfan 1, endosulfan 2). In at least some embodiments, the test sample is a botanical test sample, an aqueous sample, or a clinical sample and/or an extract of a marijuana or hemp product (e.g., flowers, concentrates, edibles, topicals, smokables). In at least some embodiments, the triple quadrupole mass spectrometer is configured to detect an MRM transition selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524.00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1). In at least some embodiments, the second LC column eluant comprises the ammonium salt at a concentration of from 0.25 to 1.25 mM.

This Summary is not exhaustive of the scope of the present aspects and embodiments. Thus, while certain aspects and embodiments have been presented and/or outlined, it should be understood that the present aspects and embodiments are not limited to the aspects and embodiments in this Summary. Indeed, other aspects and embodiments, which may be similar to and/or different from, the aspects and embodiments presented in this Summary, will be apparent from the description, illustrations and/or claims, which follow.

It should be understood that any aspects and embodiments that are described in this Summary and do not appear in the claims that follow are preserved for later presentation in this application or in one or more continuation patent applications.

### BRIEF DESCRIPTION OF THE DRAWINGS

FIG. 1A is a schematic illustration of an embodiment of a method of detecting a pesticide.

FIG. 1B is a schematic illustration of an embodiment of a method of detecting a pesticide.

FIG. 2 is a schematic illustration of an embodiment of a liquid chromatography (LC) separation system comprising an LC column, a first mobile phase, and a second mobile phase comprising an ammonium salt.

FIG. 3A is a schematic illustration of an embodiment of an LC column comprising a first mobile phase, a second mobile phase, and an ammonium salt.

FIG. 3B is a schematic illustration of an embodiment of a reverse phase chromatographic separation column comprising a first mobile phase, a second mobile phase, an ammonium salt, and a test sample.

FIGS. 4A and 4B are chromatograms of acetonitrile samples spiked with a pesticide standard containing 100 ppb cyfluthrin, showing the signal for cyfluthrin obtained with and without the addition of ammonium hydroxide to the LC column eluant. FIG. 4A, MRM transition 507.80/75.00. FIG. 4B, MRM transition 507.80/31.00.

FIGS. 5A-5B are chromatograms of acetonitrile samples spiked with a pesticide standard containing 100 ppb cyfluthrin, showing the signal for cyfluthrin obtained with the addition of ammonium hydroxide to the LC column eluant. FIG. 5A, MRM transition 507.80/75.00. FIG. 5B, MRM transition 507.80/31.00.

FIGS. 6A-6B are chromatograms of acetonitrile samples spiked with a pesticide standard containing 100 ppb cyfluthrin, showing the signal for cyfluthrin obtained with the addition of ammonium bicarbonate to the LC column eluant. FIG. 6A, MRM transition 507.80/31.00. FIG. 6B, MRM transition 507.80/75.00.

FIG. 7 is a chromatogram of an acetonitrile sample spiked with 100 ppb cyfluthrin, showing the signal for cyfluthrin obtained with the addition of ammonium formate to the LC column eluant. MRM transition 478.00/45.00.

FIG. 8 is a chromatogram of an acetonitrile sample spiked with 100 ppb cyfluthrin, showing the signal for cyfluthrin obtained with the addition of ammonium fluoride to the LC column eluant. MRM transition 472.00/39.00.

FIGS. 9A and 9B are chromatograms of acetonitrile samples spiked with a pesticide standard containing 100 ppb of chlordane, showing signals obtained for chlordane obtained with and without the addition of ammonium hydroxide to the LC column eluant. FIG. 9A, MRM transition 484.80/31.00. FIG. 9B, MRM transition 484.80/75.00.

FIG. 10 is a chromatogram of an acetonitrile sample spiked with a pesticide standard containing 100 ppb of chlordane, showing the signals obtained for chlordane obtained with the addition of ammonium hydroxide to the LC column eluant. MRM transition 484.80/75.00.

FIG. 11 is a chromatogram of an acetonitrile sample spiked with a pesticide standard containing 100 ppb of chlordane, showing the signals obtained for chlordane obtained with the addition of ammonium bicarbonate to the LC column eluant. MRM transition 484.80/75.00.

FIG. 12 is a chromatogram of an acetonitrile sample spiked with 100 ppb chlordane, showing the signals for chlordane obtained with the addition of ammonium fluoride to the LC column eluant. MRM transition 446.80/39.00.

FIG. 13 is a chromatogram of an acetonitrile sample spiked with 100 ppb chlordane, showing the signals for chlordane obtained with the addition of ammonium chloride to the LC column eluant. MRM transition 442.70/35.00.

FIG. 14 is a chromatogram of an acetonitrile sample spiked with 100 ppb chlordane, showing the signals for chlordane obtained with the addition of ammonium formate to the LC column eluant. MRM transition 454.80/45.00.

FIGS. 15A-15B are chromatograms of acetonitrile samples spiked with a pesticide standard containing 100 ppb of chlorfenapyr, showing the signal for chlorfenapyr obtained with and without the addition of ammonium hydroxide to the LC column eluant. FIG. 15A, MRM transition 482.80/31.00. FIG. 15B, MRM transition 482.80/75.00.

FIG. 16 is a chromatogram of an acetonitrile sample spiked with a pesticide standard containing 100 ppb of chlorfenapyr, showing the signal for chlorfenapyr obtained with the addition of ammonium hydroxide to the LC column eluant. MRM transition 482.80/75.00.

FIG. 17 is a chromatogram of an acetonitrile sample spiked with a pesticide standard containing 100 ppb of chlorfenapyr, showing the signal for chlorfenapyr obtained with the addition of ammonium bicarbonate to the LC column eluant. MRM transition 482.80/75.00.

FIG. 18 is a chromatogram of an acetonitrile sample spiked with 100 ppb chlordane, showing the signal for chlordane obtained with the addition of ammonium fluoride to the LC column eluant. MRM transition 446.75/39.03.

FIG. 19 is a chromatogram of an acetonitrile sample spiked with 100 ppb chlordane, showing the signal for chlordane obtained with the addition of ammonium chloride to the LC column eluant. MRM transition 442.72/35.00.

FIG. 20 is a chromatogram of an acetonitrile sample spiked with 100 ppb chlordane, showing the signal for chlordane obtained with the addition of ammonium formate to the LC column eluant. MRM transition 452.80/45.00.

FIGS. 21A-21B are chromatograms of acetonitrile samples spiked with a pesticide standard containing 100 ppb of cypermethrin, showing the signal for cypermethrin obtained with and without the addition of ammonium hydroxide to the LC column eluant. FIG. 21A, MRM transition 489.90/31.00. FIG. 21B, MRM transition 489.90/75.00.

FIGS. 22A-22B are chromatograms of acetonitrile samples spiked with a pesticide standard containing 100 ppb of cypermethrin, showing the signal for cypermethrin obtained with the addition of ammonium hydroxide to the LC column eluant. FIG. 22A, MRM transition 489.90/31.00. FIG. 22B, MRM transition 489.90/75.00.

FIGS. 23A-23B are chromatograms of acetonitrile samples spiked with a pesticide standard containing 100 ppb of cypermethrin, showing the signal for cypermethrin obtained with the addition of ammonium bicarbonate. FIG. 23A, MRM transition 489.90/31.00. FIG. 23B, MRM transition 489.90/75.00 to the LC column eluant.

FIG. 24 is a chromatogram of an acetonitrile sample spiked with 100 ppb cypermethrin, showing the signal for cypermethrin obtained with the addition of ammonium formate. MRM transition 413.90/26.00 to the LC column eluant.

FIGS. 25A-25B are chromatograms of acetonitrile samples spiked with 100 ppb cypermethrin, showing the signal for cypermethrin obtained with the addition of ammonium fluoride to the LC column eluant. FIG. 25A, MRM transition 454.02/39.00. FIG. 25B, MRM transition 413.90/26.00.

FIGS. 26A-26B are chromatograms of acetonitrile samples spiked with 100 ppb endosulfan 2. FIG. 26A, atmospheric chemical ionization (APCI) source, MRM transition 404.80/35.00. FIG. 26B, electrospray ionization source (ESI) source, ammonium hydroxide additive, MRM transition 480.80/75.00.

FIGS. 27A-27B are chromatograms of acetonitrile samples spiked with 100 ppb endosulfan 1. FIG. 27A, APCI source, MRM transition 404.80/35.00. FIG. 27B, ESI source, ammonium hydroxide additive, MRM transition 480.80/75.00.

FIG. 28A is a chromatogram of an acetonitrile sample spiked with 3 ppb chlordane-2. APCI source, negative ion mode, MRM transition 441.80/35.10.

FIG. 28B is a chromatogram of an acetonitrile sample spiked with 1 ppb chlordane, showing the signal for chlordane obtained with the addition of ammonium hydroxide to the LC column eluant. ESI source, negative ion mode, MRM transition 484.80/75.00.

FIG. 29A is a chromatogram of an acetonitrile sample spiked with a pesticide standard containing 1 ppb chlorfenapyr, showing the signal for chlorfenapyr. APCI source, negative ion mode, MRM transition 346.90/79.00.

FIG. 29B is a chromatogram of an acetonitrile sample spiked with a pesticide standard containing 1 ppb chlorfenapyr, showing the signal for chlorfenapyr obtained with the addition of ammonium hydroxide to the LC column eluant. ESI source, negative ion mode, MRM transition 482.80/75.00.

FIGS. 30A-30B are chromatograms of acetonitrile samples spiked with 100 ppb cyhalothrin, showing the signal for cyhalothrin obtained with the addition of ammonium hydroxide to the LC column eluant. FIG. 30A, MRM transition 524.00/31. FIG. 30B, MRM transition 524.00/75.00.

FIG. 31 is a chromatogram of an acetonitrile sample spiked with 100 ppb cyhalothrin, showing the signal for cyhalothrin obtained with the addition of ammonium fluoride to the LC column eluant. MRM transition 488.02/39.00.

FIG. 32 is a chromatogram of an acetonitrile sample spiked with 100 ppb cyhalothrin, showing the signal for cyhalothrin obtained with the addition of ammonium formate to the LC column eluant. MRM transition 448.00/26.00.

FIGS. 33A-33B are chromatograms of acetonitrile samples spiked with a pesticide standard, showing the signal for cyhalothrin obtained with and without the addition of ammonium hydroxide to the LC column eluant. FIG. 33A, 5 ppb cyfluthrin, no ammonium hydroxide, MRM transition 451.10/191.00. FIG. 33B, 1 ppb cyfluthrin, with ammonium hydroxide, MRM transition 507.80/75.00.

### DETAILED DESCRIPTION

The ionization efficiency of certain pesticides is quite low with the use of the most commonly used additives, making it difficult to measure very low levels of these pesticides in cannabis, food, water, and other matrices. This is particularly problematic for testing cannabis for pesticides in US states such as Florida and California and in other countries such as Canada which have rigorous and stringent testing regulations.

This disclosure provides liquid chromatography tandem mass spectrometer (LC-MS/MS) methods and systems for detecting low levels of pesticides in a test sample. In the disclosed methods and systems, ammonium hydroxide, ammonium bicarbonate, or ammonium fluoride are used as additives before exposing a test sample to an ESI source in negative ionization mode. Use of these additives improves the signal for certain pesticides by a factor of from 2 to 20 using an ESI source in negative ion mode, thereby improving detection limits for these pesticides in a variety of test samples to less than 1 ppb. The working Examples below demonstrate improved signals for chlordane, chlorfenapyr, cyfluthrin, cyhalothrin, cypermethrin, endosulfan 1, and endosulfan 2. The systems and methods disclosed here are not limited to these pesticides and can be extended to other types of pesticides and other analytes.

The disclosed methods and systems are particularly useful for detection and/or quantification of pesticides in samples comprising cannabis plant material. Unless otherwise specified in this disclosure, “cannabis” encompasses all varieties of cannabis plants. Cannabis plants include, but are not limited to, cannabis plants containing relatively high levels of tetrahydrocannabinol (THC), such as marijuana; and cannabis plants containing lower levels of THC and higher levels of cannabidiol (CBD), such as hemp. The disclosed systems and methods can be applied to detect pesticides in a variety of cannabis samples, including marijuana and hemp products such as flowers; concentrates (e.g., oils, tinctures, distillates); edibles such as candy (e.g., gummies, chocolates), cooking oil, baked goods, beverages (e.g., milk, water), ice cream; topicals (e.g., gels, ointments, lotions), botanical samples such as other edible plants and plant products (e.g., herbs, vegetables, fruits, edible flowers, spices, olive oil); other medicinal plants and plant products; other plants and plant products which can be smoked (“smokables,” e.g., tobacco, mint, sage); meats; environmental samples (e.g., water); and clinical samples (e.g., blood serum, urine).

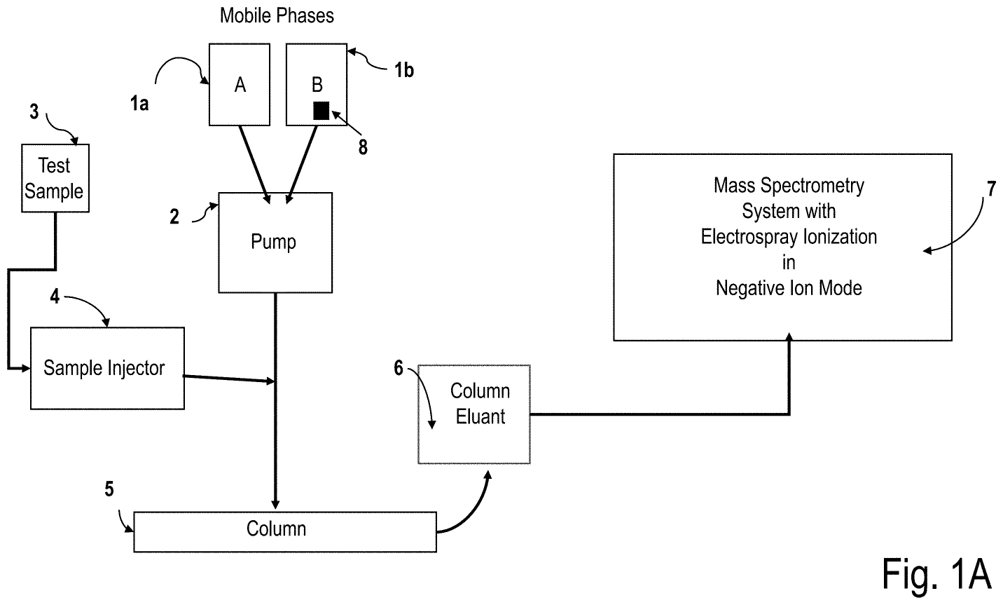

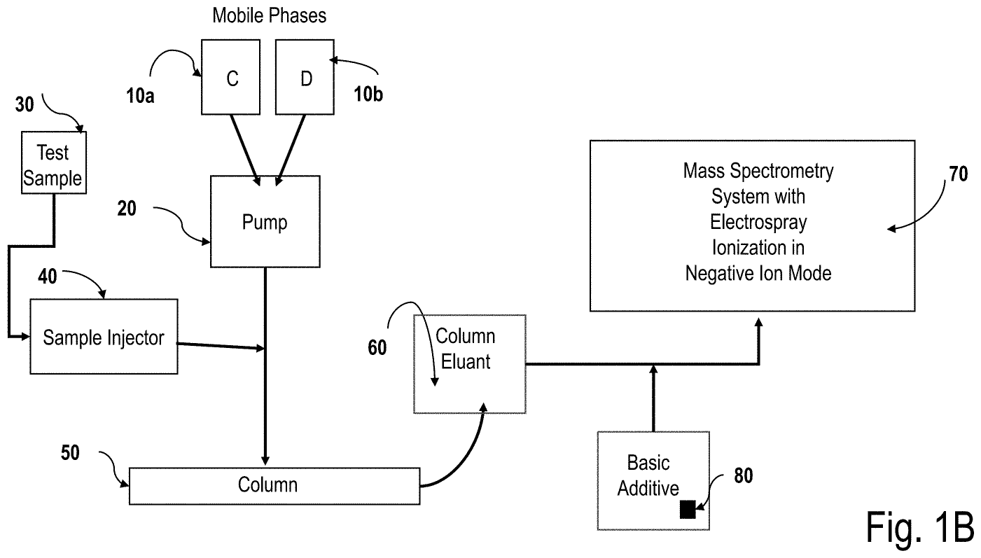

An illustrative and non-limiting embodiment is shown in FIG. 1A. In this embodiment, either or both of the mobile phases comprises an ammonium salt. Solvent reservoir la contains a first mobile phase (A), and solvent reservoir 1b contains a second mobile phase (B). In some embodiments, mobile phase 1a is water. In some embodiments, mobile phase 1b is methanol. In the embodiment shown in FIG. 1A, mobile phase 1b comprises ammonium salt 8. Ammonium salt 8 is selected from the group consisting of ammonium hydroxide, ammonium bicarbonate, and ammonium fluoride. The concentration of ammonium salt 8 can vary independently in the two mobile phases from 0 mM to 100 mM, as long as one of the mobile phases contains a concentration of ammonium salt 8 greater than 0 mM. In some embodiments, the concentration of ammonium salt 8 in the two mobile phases independently varies between 0.1 and 100 mM. In some embodiments, the concentration of the ammonium salt in one of the mobile phases is 0 mM, and the concentration of the ammonium salt in the other mobile phase varies from 0.1 mM to 100 mM (e.g., 0.1 mM to 50 mM, 0.25 mM to 1.25 mM, 10 mM to 50 mM, 10 mM to 100 mM, 20 mM to 100 mM).

Mobile phases 1a and 1b are pumped via pump 2 to a liquid chromatography column 5 that is stable at pH range of about 7 to about 12. Suitable columns include silica-based columns or polymer-based columns (e.g., DVB, PS-DBV polymer-based columns).

Test sample 3 is loaded onto liquid chromatography column 5 via sample injector 4. In some embodiments, test sample 3 is a botanical test sample, an environmental sample, or a clinical sample and/or a marijuana or hemp product (e.g., flowers, concentrates, edibles, topicals, smokables). In at least some embodiments, test sample 3 comprises a pesticide (e.g., chlordane, chlorfenapyr, cyfluthrin, cyhalothrin, cypermethrin, endosulfan 1, endosulfan 2).

At this point, liquid chromatography column 5 contains a “mobile phase composition,” which comprises mobile phase la, mobile phase 1b, ammonium salt 8, and test sample 3. The proportion of the two mobile phases is shifted over time to create a gradient that passes over LC column 5. The resulting column eluant 6 is subjected to an electrospray ionization source in negative ion mode and Multiple Reaction Monitoring (MRM) transitions for pesticide(s) using tandem MS/MS mass spectrometer system 7.

Another illustrative and non-limiting embodiment is shown in FIG. 1B. In this embodiment, the ammonium salt is added to the eluant from the liquid chromatography column. Solvent reservoir 10a contains a first mobile phase (C) and solvent reservoir 10b contains a second mobile phase (D). In some embodiments, mobile phase 10a is water. In some embodiments, mobile phase 10b is methanol. Mobile phases 10a and 10b are pumped via pump 20 to a liquid chromatography (LC) column 50. In such embodiments, in which the ammonium salt is added to the LC column eluant, any type of LC column can be used (e.g., columns in which the solid phase is C18, biphenyl, C4, C8, phenyl, C1, pentafluorophenyl, C30, polar embedded, polar end-capped, porous graphitic carbon, phenyl-hexyl, alkyl).

Test sample 30 is loaded onto LC column 50 via sample injector 40. In some embodiments, test sample 30 is a botanical test sample, an environmental sample, or a clinical sample and/or a marijuana or hemp product (e.g., flowers, concentrates, edibles, topicals, smokables). In at least some embodiments, test sample 30 comprises a pesticide (e.g., chlordane, chlorfenapyr, cyfluthrin, cyhalothrin, cypermethrin, endosulfan 1, endosulfan 2).

At this point, the liquid chromatography column 50 contains a “mobile phase composition,” which comprises mobile phase 10a, mobile phase 10b, and test sample 30. The proportion of the two mobile phases is shifted over time to create a gradient that passes over LC column 50. Ammonium salt 80 is added to the resulting LC column eluant 60, which is then subjected to an electrospray ionization source in negative ion mode and Multiple Reaction Monitoring (MRM) transitions for pesticide(s) using a tandem MS/MS mass spectrometer system 70. Ammonium salt 80 is selected from the group consisting of ammonium hydroxide, ammonium bicarbonate, and ammonium fluoride. The concentration of ammonium salt 80 can range from 0.1 mM to 100 mM (e.g., 0.1 mM to 50 mM, 0.25 mM to 1.25 mM, 10 mM to 50 mM, 10 mM to 100 mM, 20 mM to 100 mM).

Liquid Chromatography Separation System

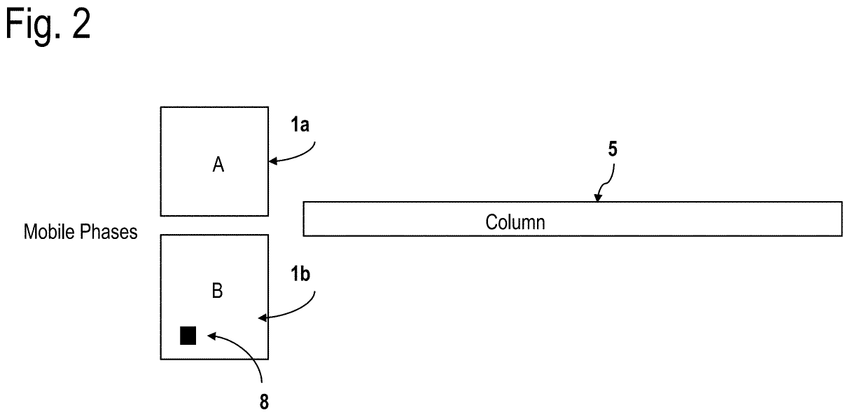

In some embodiments, this disclosure provides a liquid chromatography separation system. An illustrative and non-limiting embodiment is shown in FIG. 2. In this embodiment, the liquid chromatography separation system comprises a liquid chromatography column 5, a first mobile phase la, and a second mobile phase 1b, In some embodiments, mobile phase 1a is water. In some embodiments, mobile phase 1b is methanol. In the embodiment of FIG. 2, mobile phase 1b comprises ammonium salt 8. In other embodiments, each of mobile phases 1a and 1b comprise ammonium salt 8. Ammonium salt 8 is selected from the group consisting of ammonium hydroxide, ammonium bicarbonate, and ammonium fluoride. The concentration of ammonium salt 8 can vary independently in mobile phases 1a and 1b from 0 mM to 100 mM, as long as one of mobile phases 1a and 1b contains a concentration of ammonium salt 8 that is greater than 0 mM. In some embodiments, the concentration of ammonium salt 8 in mobile phase 1a is 0 mM, and the concentration of ammonium salt 8 in second mobile phase 1b independently vary between 0.1 and 100 mM. In some embodiments, the concentration of ammonium salt 8 in mobile phase 1a is 0 mM, and the concentration of ammonium salt 8 in mobile phase 1b varies from 0.1 mM to 100 mM (e.g., 0.1 mM to 50 mM, 0.25 mM to 1.25 mM, 10 mM to 50 mM, 10 mM to 100 mM, 20 mM to 100 mM).

Liquid Chromatography Column

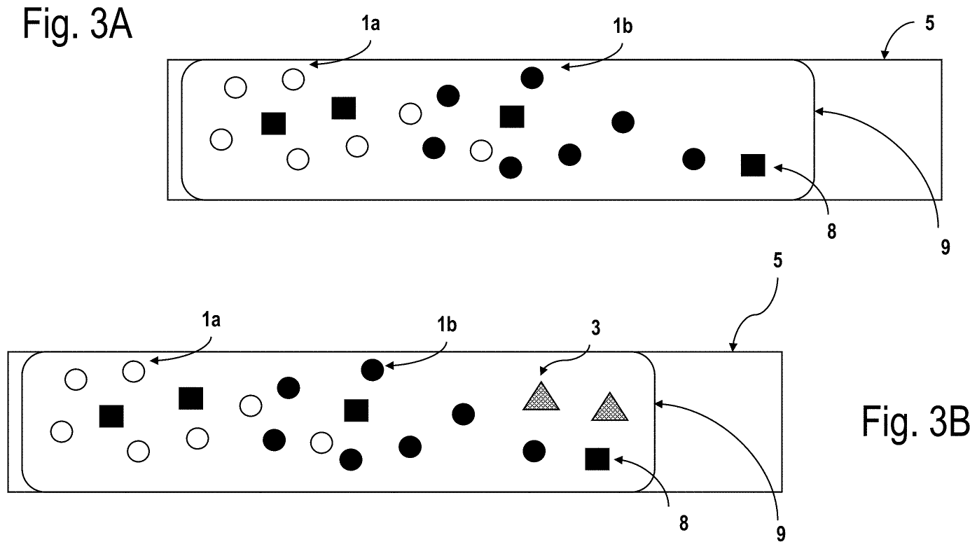

In some embodiments, this disclosure provides a liquid chromatography column. An illustrative and non-limiting embodiment is shown in FIG. 3A. The liquid chromatography column comprises mobile phase composition 9, wherein the mobile phase composition comprises a first mobile phase la, a second mobile phase 1b, and ammonium salt 8. In some embodiments, mobile phase 1a is water. In some embodiments, mobile phase 1b is methanol.

Ammonium salt 8 is selected from the group consisting of ammonium fluoride, ammonium bicarbonate, and ammonium hydroxide. The concentration of ammonium salt 8 ranges from 0.1 mM to 100 mM. In some embodiments, the concentration of ammonium salt 8 varies from 0.1 mM to 100 mM (e.g., 0.1 mM to 50 mM, 0.25 mM to 1.25 mM, 10 mM to 50 mM, 10 mM to 100 mM, 20 mM to 100 mM).

In some embodiments, mobile phase composition 9 comprises a test sample 3. An illustrative and non-limiting embodiment is shown in FIG. 3B. In some embodiments, test sample 3 is a botanical test sample, an environmental sample, or a clinical sample. In some embodiments, test sample 3 is an extract of a marijuana or hemp product. In some embodiments, the marijuana or hemp product is selected from the group consisting of flowers, concentrates, edibles, topicals, and smokables. In some embodiments, test sample 3 comprises a pesticide, e.g., chlordane, chlorfenapyr, cyfluthrin, cyhalothrin, cypermethrin, endosulfan 1, endosulfan 2.

Liquid Chromatography-Tandem Mass Spectrometer System

Liquid chromatography columns and liquid chromatography separation systems such as those described above can be part of a liquid chromatography tandem mass spectrometer (LC-MS/MS) system, which also comprises a triple quadrupole mass spectrometer. The triple quadrupole mass spectrometer can be configured to detect MRM transitions associated with various pesticides, such as chlordane, chlorfenapyr, cyfluthrin, cyhalothrin, cypermethrin, endosulfan 1, endosulfan 2. In some embodiments, the MRM transitions are selected from the group consisting of 507.80/75.00, 507.80/31.00, and 472.00/39.00 (cyfluthrin); 484.80/31.00, 484.80/75.00, and 446.80/39.00 (chlordane), 482.80/31.00, 482.80/75.00, and 446.75/39.03 (chlorfenapyr), 489.90/31.00, 489.90/75.00, 454.02/39.00, and 413.90/26.00 (cypermethrin); 480.80/75.00 (endosulfan 2), 480.80/75.00 (endosulfan 1), and 524.00/31, 524.00/75.00, and 488.02/39.00 (cyhalothrin).

Methods for Detecting Pesticides

This disclosure provides methods for detecting pesticides (e.g. chlordane, chlorfenapyr, cyfluthrin, cyhalothrin, cypermethrin, endosulfan 1, endosulfan 2) in a test sample. In some embodiments, the test sample is a botanical test sample, an environmental sample, or a clinical sample. In some embodiments, the test sample is an extract of a marijuana or hemp product. In some embodiments, the marijuana or hemp product is selected from the group consisting of flowers, concentrates, edibles, topicals, and smokables.

In at least some embodiments, a test sample is processed using a liquid chromatography column as described above, which provides a liquid chromatography (LC) column eluant comprising the test sample and the ammonium salt. The LC column eluant is then tested for the presence of the pesticide(s) using a triple quadrupole mass spectrometer configured to detect one or more MRM transitions associated with particular pesticides (e.g., chlordane, chlorfenapyr, cyfluthrin, cyhalothrin, cypermethrin, endosulfan 1, endosulfan 2). In some embodiments, the MRM transitions are selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524.00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).

In at least some embodiments, a test sample is processed using a liquid chromatography separation system as described above, which provides a first LC column eluant. The ammonium salt is added to the first LC column eluant to form a second LC column eluant. The second LC column eluant is then tested for the presence of the pesticide using a triple quadrupole mass spectrometer configured to detect one or more MRM transitions associated with particular pesticides. In some embodiments, the MRM transitions are selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524.00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).

Those skilled in the art will appreciate that there are numerous variations and permutations of the above described embodiments that fall within the scope of the appended claims.

### EXAMPLE 1

This example demonstrates the detection of pesticides spiked into acetonitrile at a concentration of 100 ppb, using an ESI source method in negative ion mode and using ammonium hydroxide, ammonium bicarbonate, ammonium fluoride, ammonium formate, or ammonium chloride as additives.

Pesticides such as cyfluthrin, chlordane and others disclosed in this application were ionized by formation of negative ion adducts with addition of reagent ion (HF₂⁻) having nominal mass of 39 from the ammonium fluoride additive. The mechanism of ionization with ammonium fluoride additive is: M+[HF₂]⁻→[M+HF₂]⁻, where M is any pesticide or analyte.

Similarly, pesticides such as cyfluthrin, chlordane and others disclosed in this application were ionized by formation of negative ion adducts with addition of a reagent ion having nominal mass of 75. This reagent ion is postulated to have chemical composition of CH₃CO₃⁻ and is produced in the ESI source in negative ion mode with addition of a basic additive, such as ammonium bicarbonate, ammonium hydroxide, and others. The postulated mechanism of ionization with either ammonium bicarbonate or ammonium hydroxide as an additive is: M+[CH₃CO₃]⁻→[M+CH₃CO₃]⁻, where M is any pesticide or analyte.

Chromatographic separation was conducted using a PerkinElmer Quasar SPP Pesticides (4.6×100 mm, 2.7 μm) C18 LC column, and detection was achieved using a PerkinElmer QSIGHT™ LC/MS/MS mass spectrometer with electrospray ion source. The composition of mobile phase A was water. The composition of mobile phase B was methanol. The LC flow rate was 0.8 ml/min (800 μL/min), and the injection volume was 10 μL. The LC column was equilibrated to a starting mobile phase of 80% phase B for 1.5 minutes, then maintained for 0.2 minutes and increased linearly to 95% phase B in 4.5 minutes, followed by an increase to 100% phase B at 5.5 minutes, and maintained at 100% phase B for 0.5 minutes. The method is not limited to this gradient, however; any other gradient will work with the disclosed method.

Ammonium hydroxide, ammonium carbonate, ammonium fluoride, ammonium chloride, or ammonium formate in methanol in a concentration range of 20 to 100 mM were added to the eluant from the LC column at a rate of 10 μL/min before the eluant entered the LCMSMS system with ESI source. Because the additive solution was diluted by a factor of 80 due to dilution with eluant from the LC column at flow rate of 800 μL/min before it entered the mass spectrometer, the additive concentration was in the range of 0.25 to 1.25 mM in the ESI source in the mass spectrometer.

Parameters for the mass spectrometer were as follows. The ionization source was ESI in negative ion mode. Source temperature was 150° C., the hot surface induced desolvation (HSID™) temperature interface was 150° C. Nebulizing gas (air) was 350 arbitrary units, and drying gas (nitrogen) was 150 arbitrary units.

All instrument control, data acquisition and data processing was performed using the Simplicity 3Q™ software platform.

Cyfluthrin

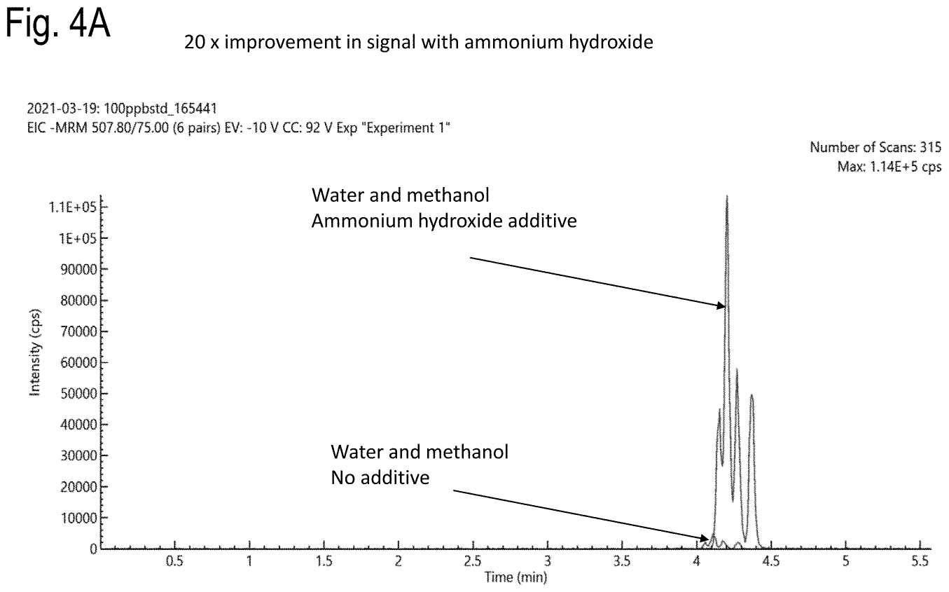

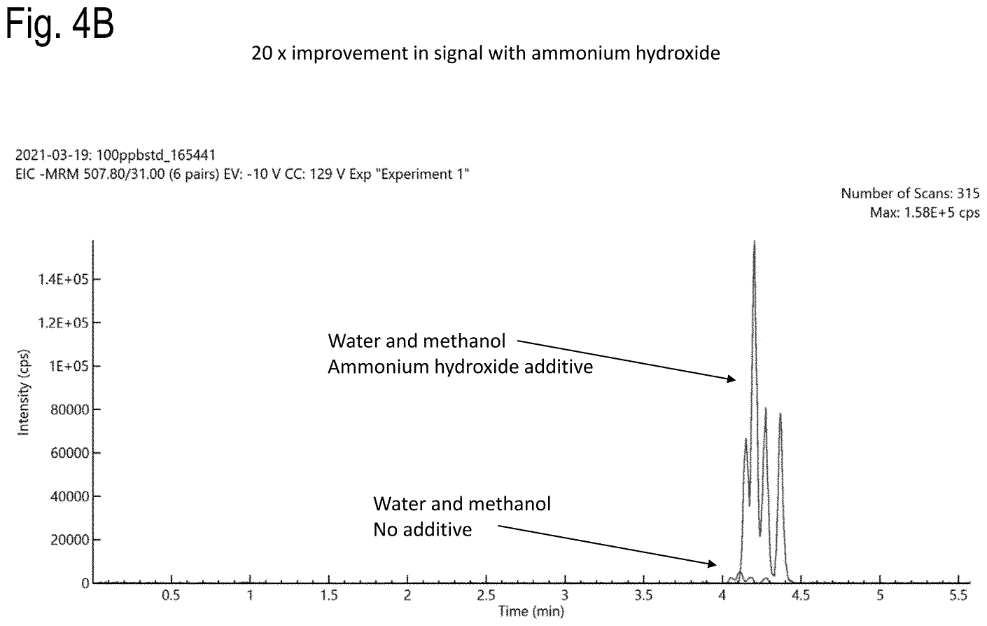

FIGS. 4A and 4B show a 20-fold improvement in the signal for cyfluthrin with ammonium hydroxide as an additive to the LC column eluant.

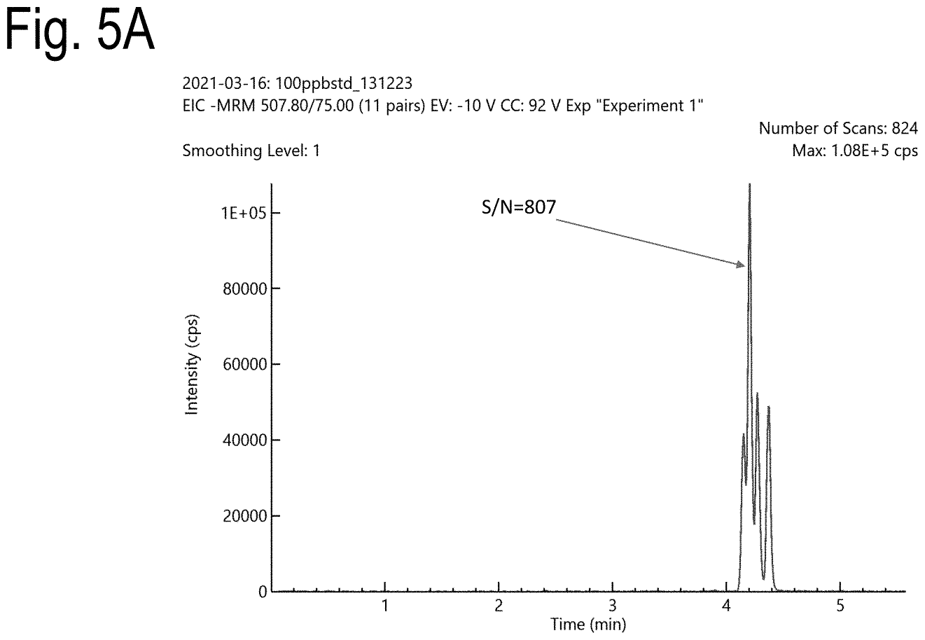

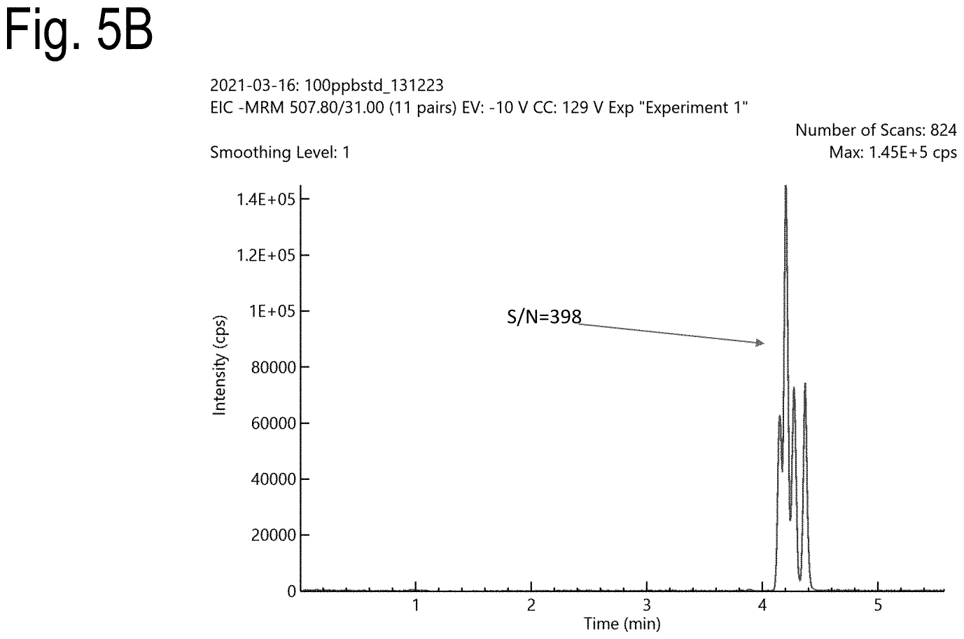

FIGS. 5A and 5B show signal to noise (S/N) ratios of 807 and 398, respectively, for cyfluthrin with ammonium hydroxide as an additive to the LC column eluant.

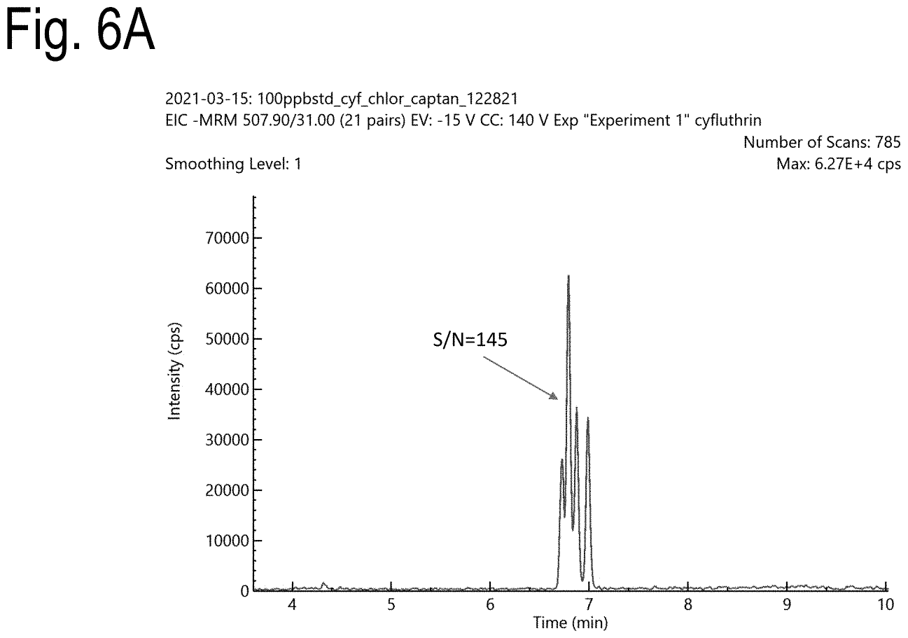

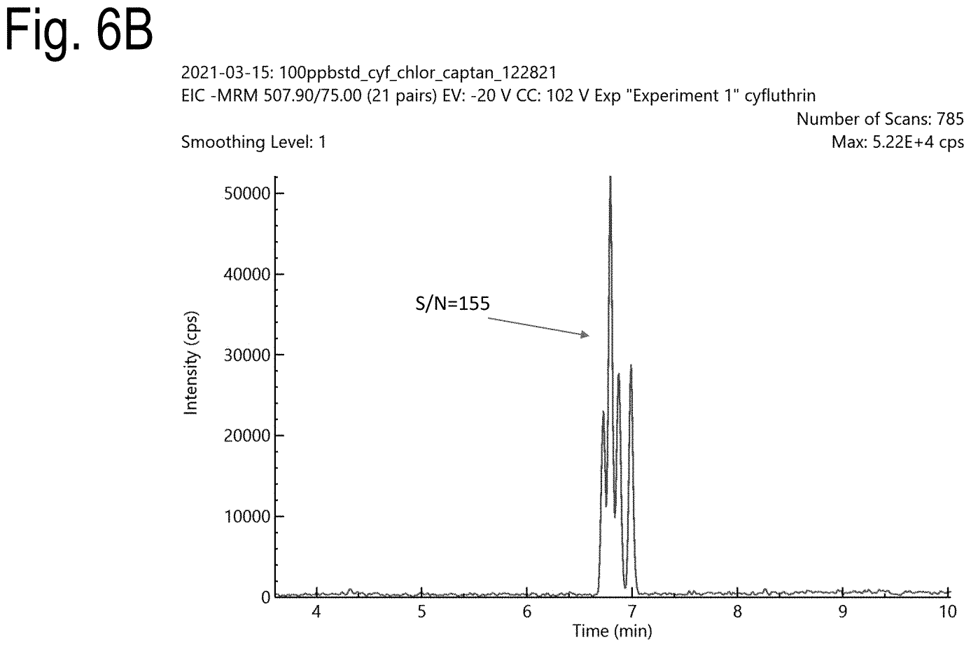

FIGS. 6A and 6B show S/N ratios of 145 and 155, respectively, for cyfluthrin using ammonium bicarbonate as an additive to the LC column eluant.

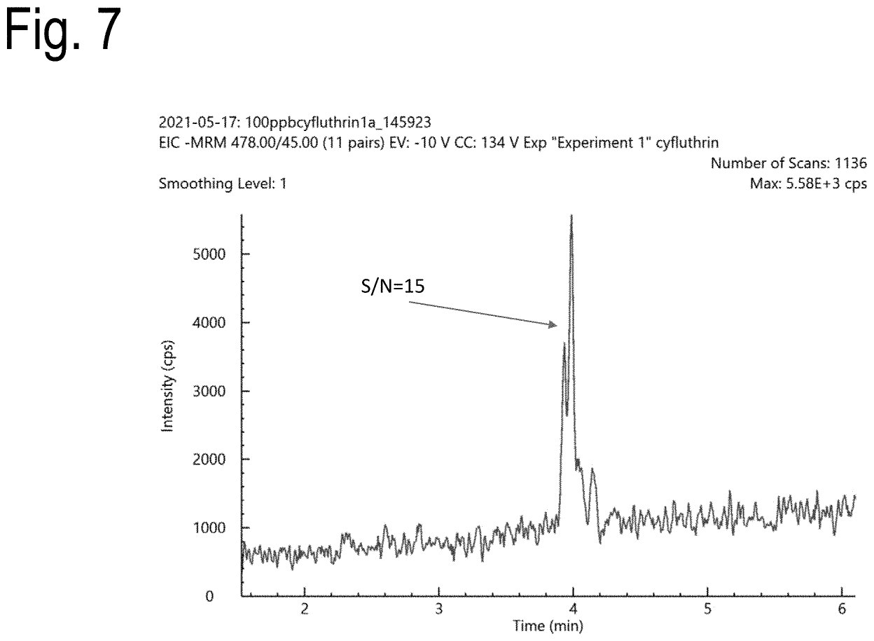

FIG. 7 shows an S/N ratio of 15 for cyfluthrin using ammonium formate as an additive to the LC column eluant.

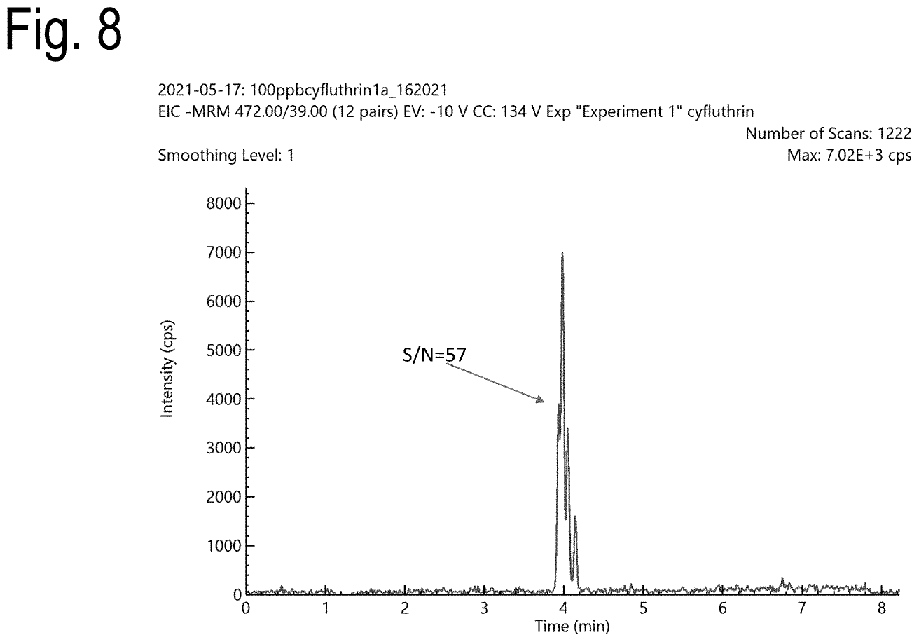

FIG. 8 shows an S/N ratio of 57 for cyfluthrin using ammonium fluoride as an additive to the LC column eluant.

Chlordane

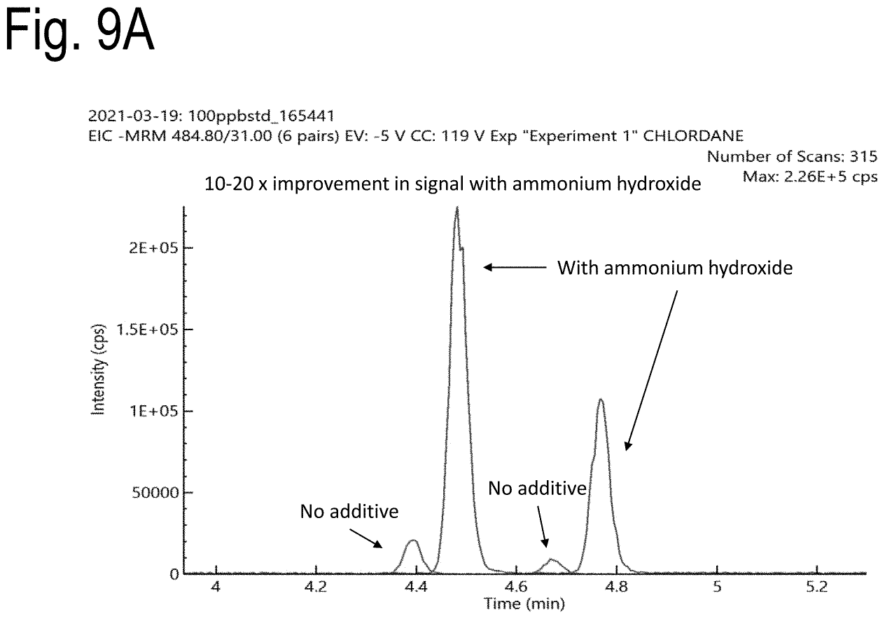

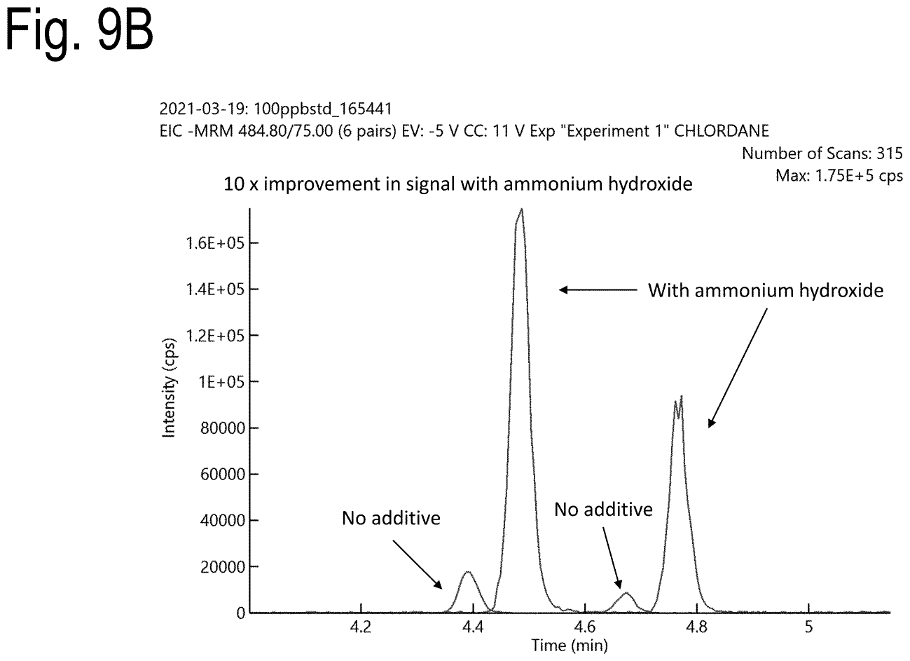

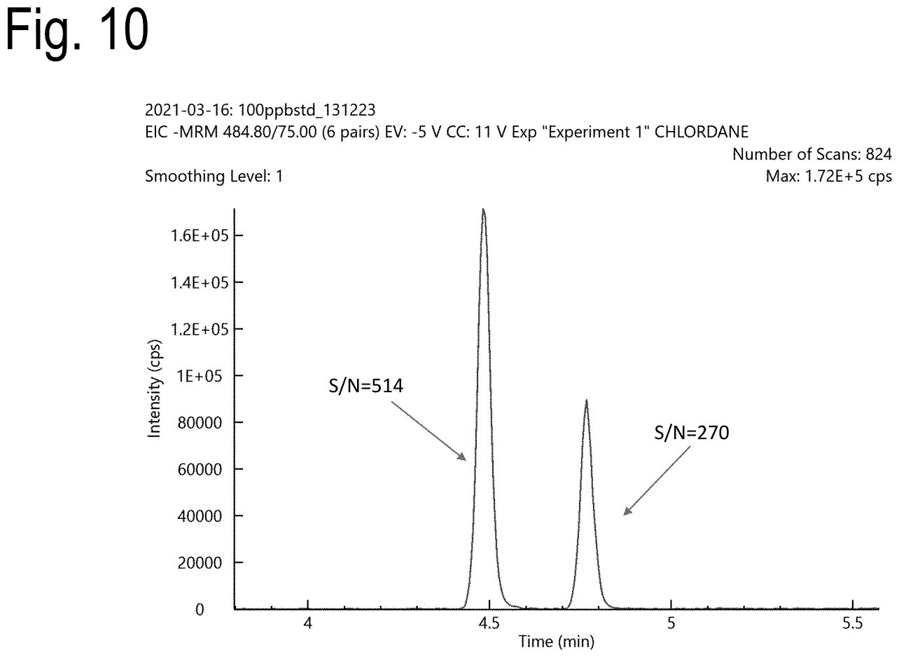

FIGS. 9A and 9B show a 10 to 20-fold improvement in the signals for chlordane using ammonium hydroxide as an additive to the LC column eluant. The S/N ratios were 514 and 270 (FIG. 10).

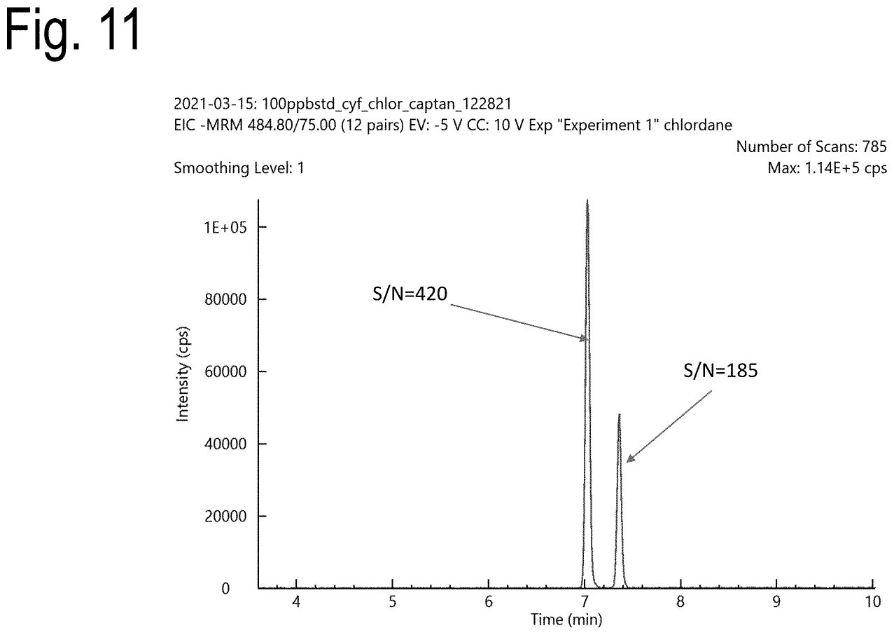

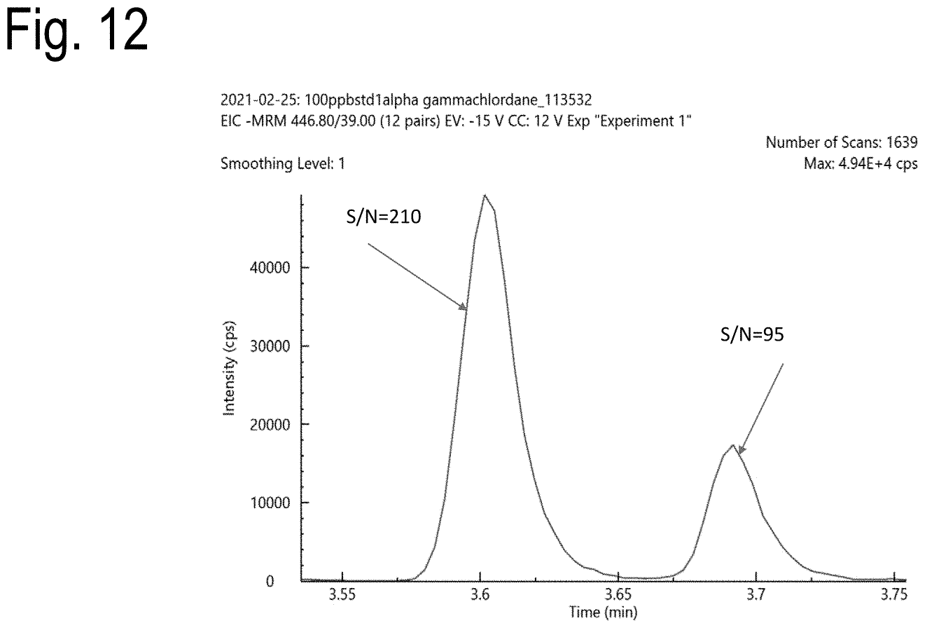

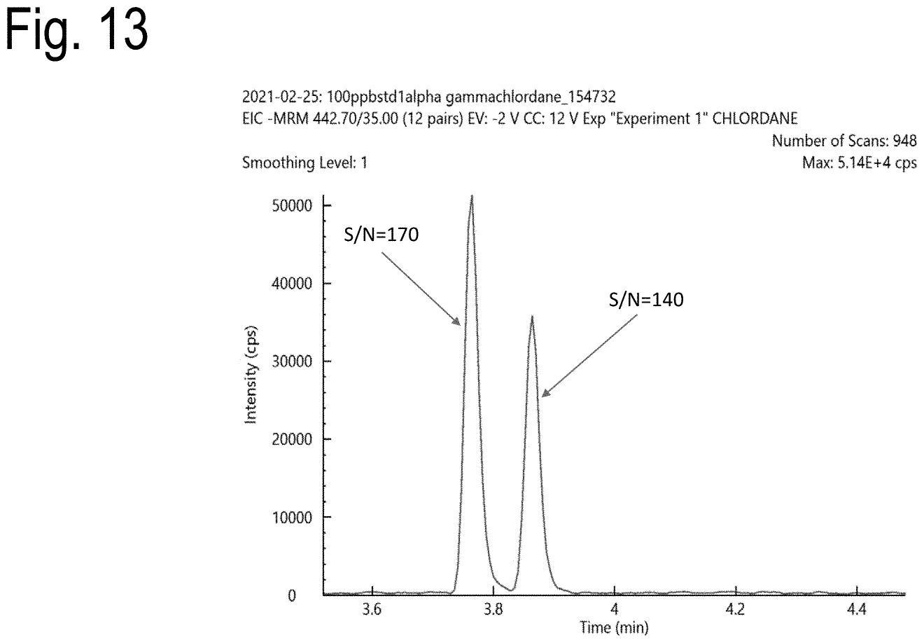

Using ammonium bicarbonate as an additive to the LC column eluant, the S/N ratios in the signals for chlordane were 420 and 185 (FIG. 11). Using ammonium fluoride, the to the LC column eluant, S/N ratios were 210 and 95; however, the intensities of the signals were lower than with ammonium hydroxide or ammonium bicarbonate (FIG. 12). Using ammonium chloride as an additive to the LC column eluant, the intensities of the signals were also lower, and the S/N ratios were 170 and 140.

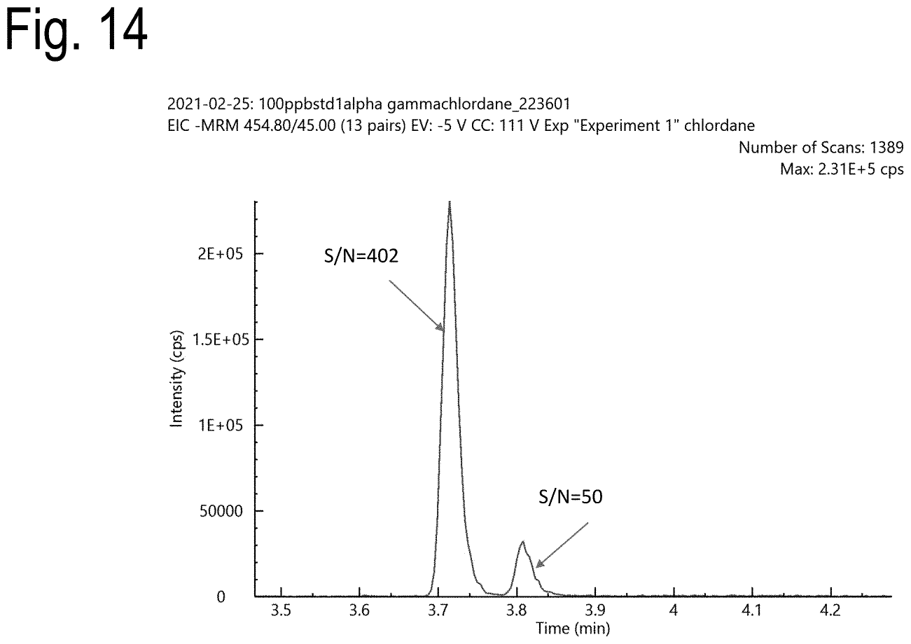

FIG. 14 shows the signal obtained for chlordane using ammonium formate as an additive to the LC column eluant. The S/N ratios were 402 and 50.

Chlorfenapyr

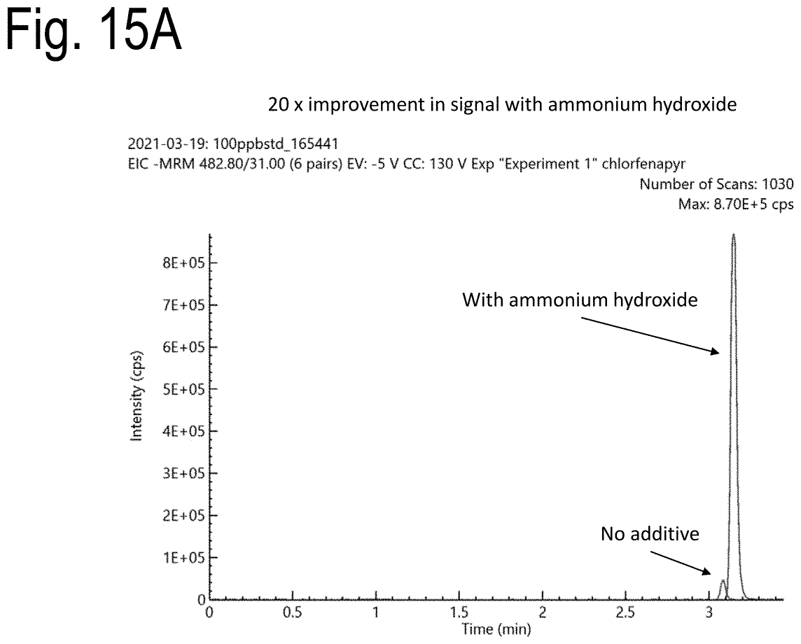

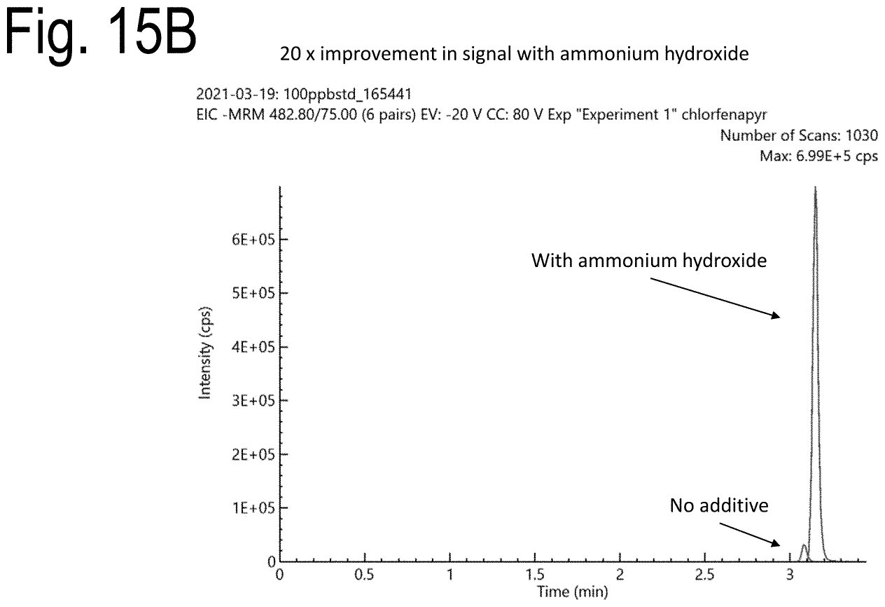

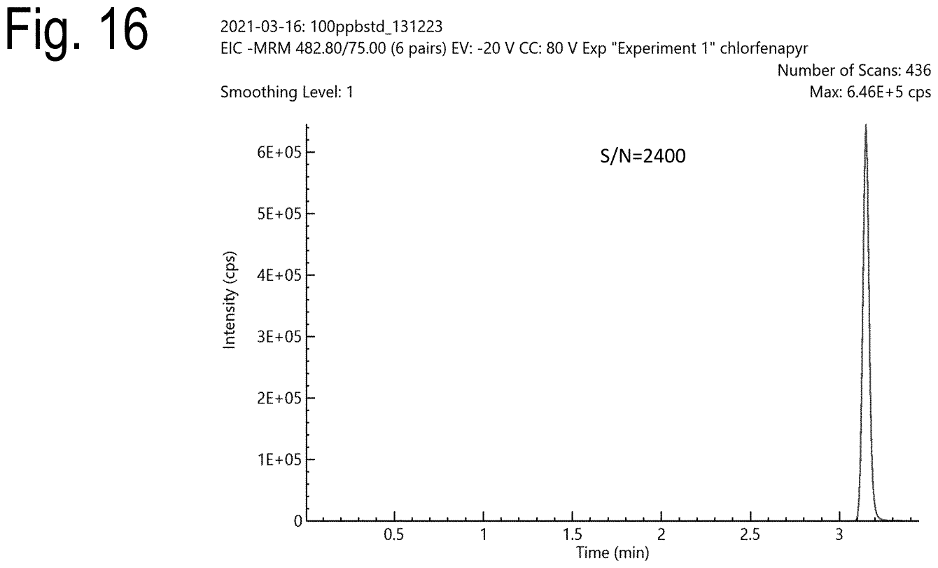

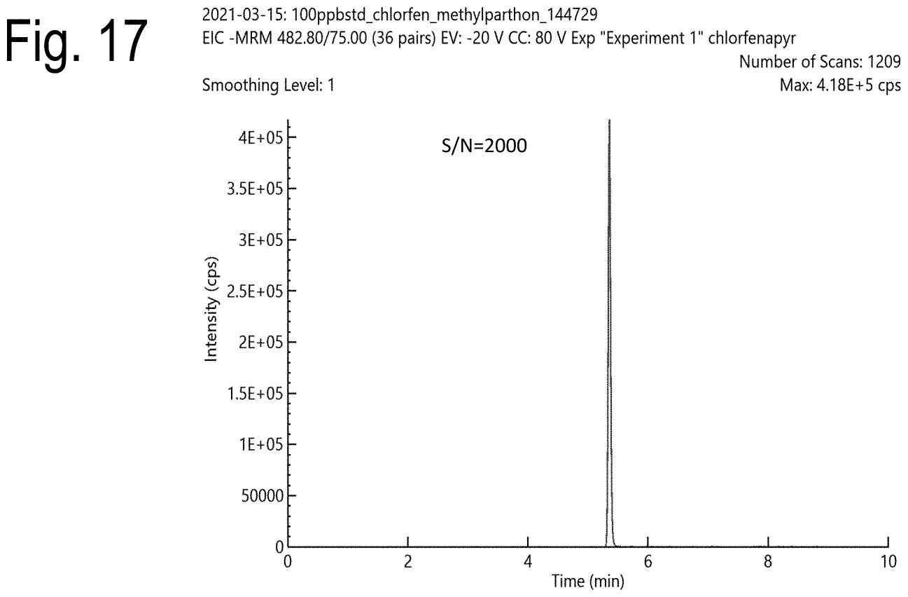

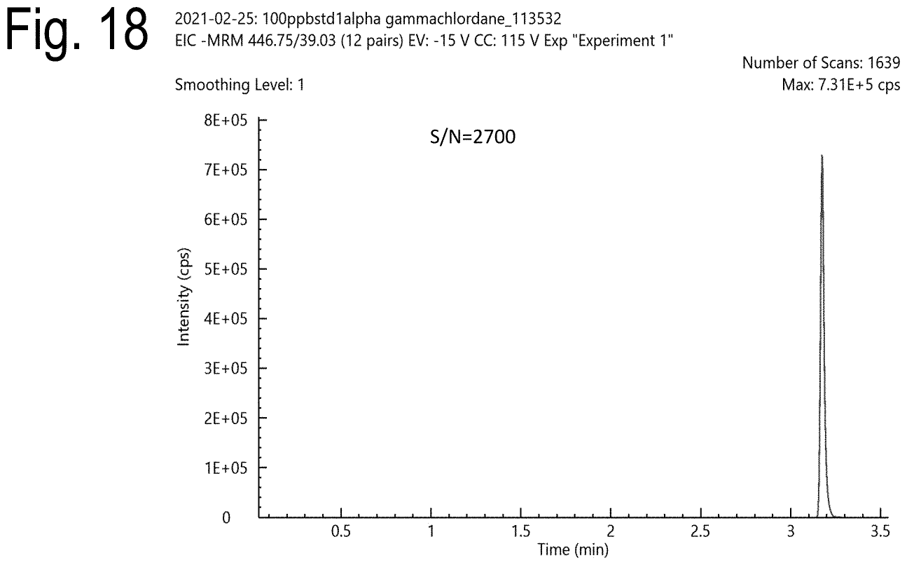

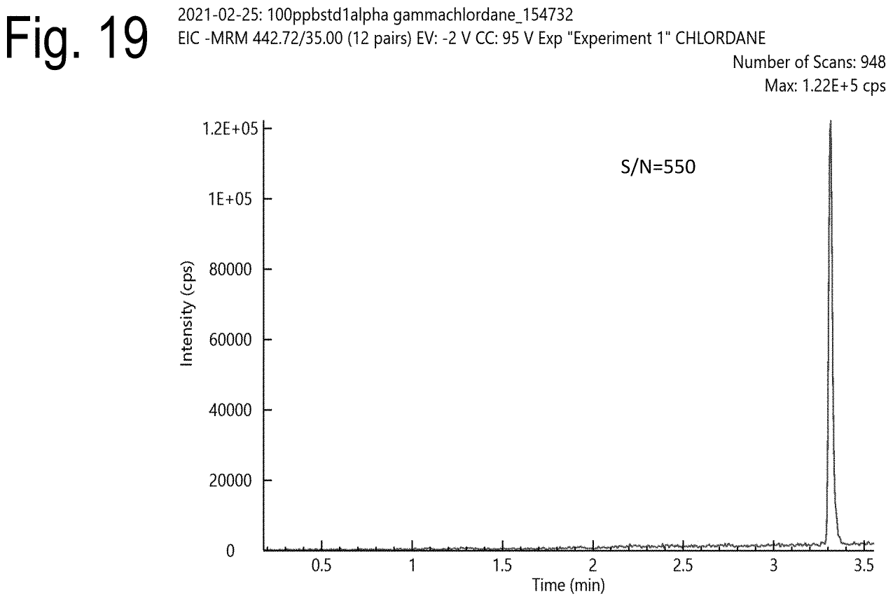

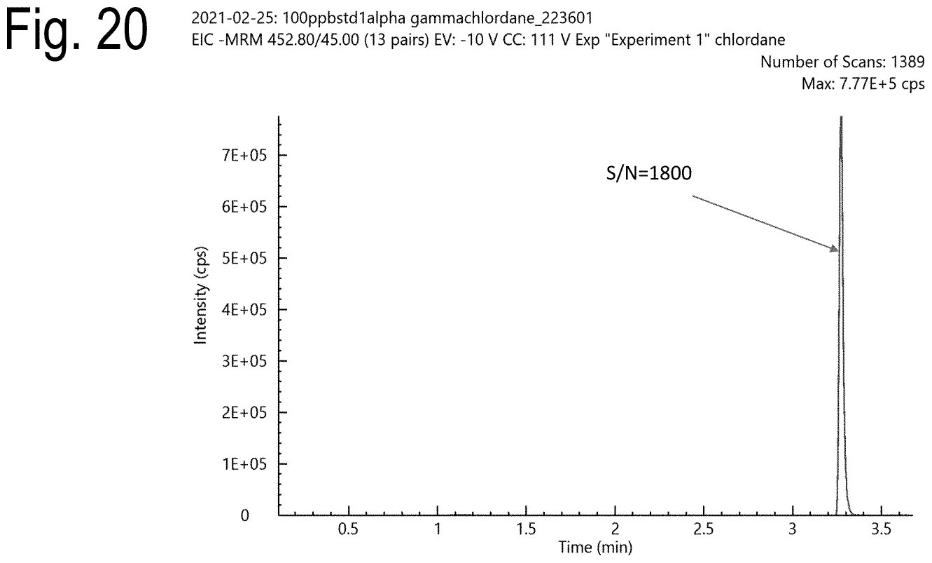

FIGS. 15A and 15B show a 20-fold improvement in the signal for chlorfenapyr with ammonium hydroxide as an additive. The S/N ratio was 2400 (FIG. 16). Using sodium bicarbonate as an additive, the S/N ratio was 2000 (FIG. 17). FIG. 18 shows a S/N ratio of 2700 using ammonium fluoride as an additive. With ammonium chloride as an additive, the S/N ratio was 550 (FIG. 19). With ammonium formate as an additive, the S/N ratio was 1800 (FIG. 20).

Cypermethrin

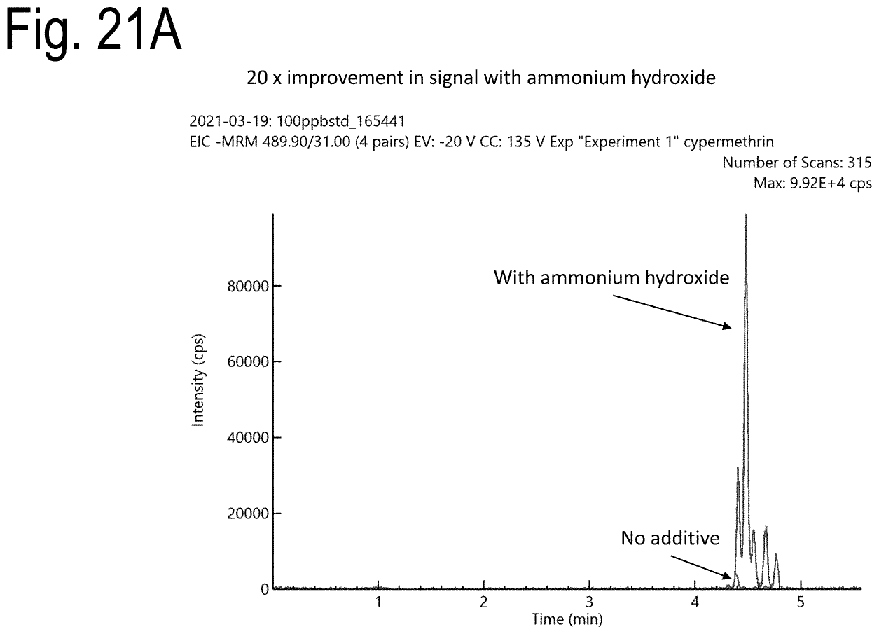

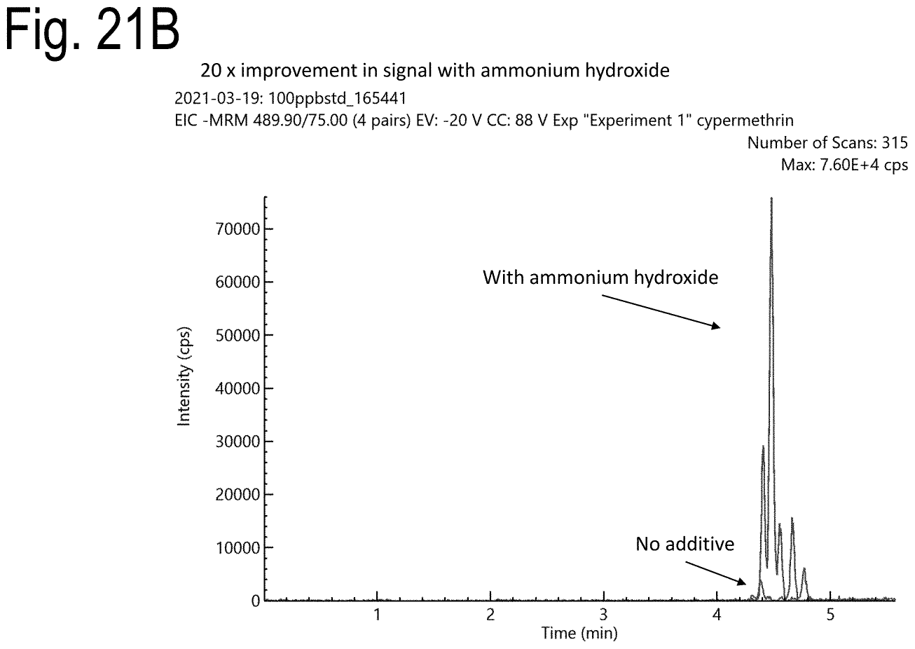

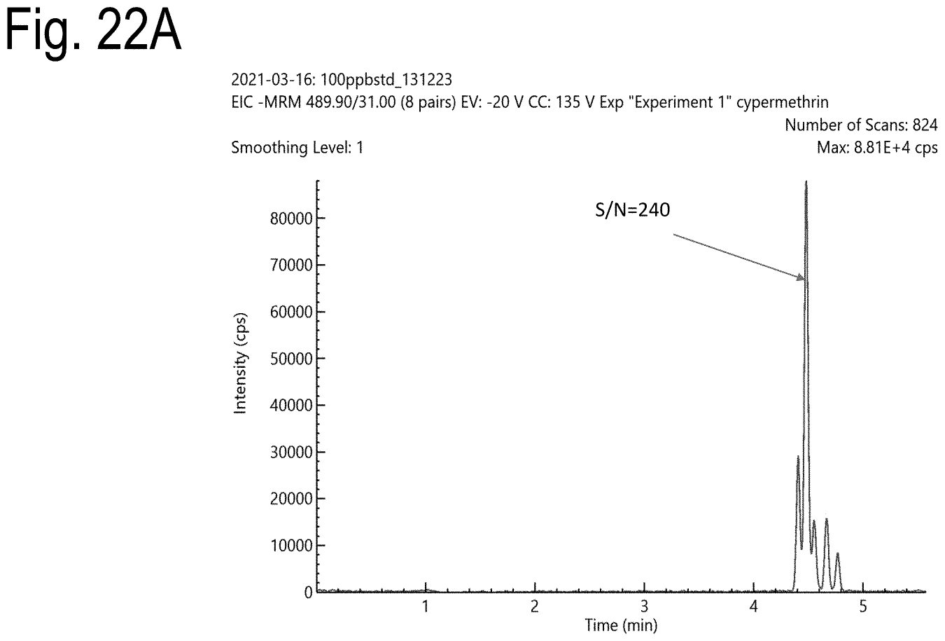

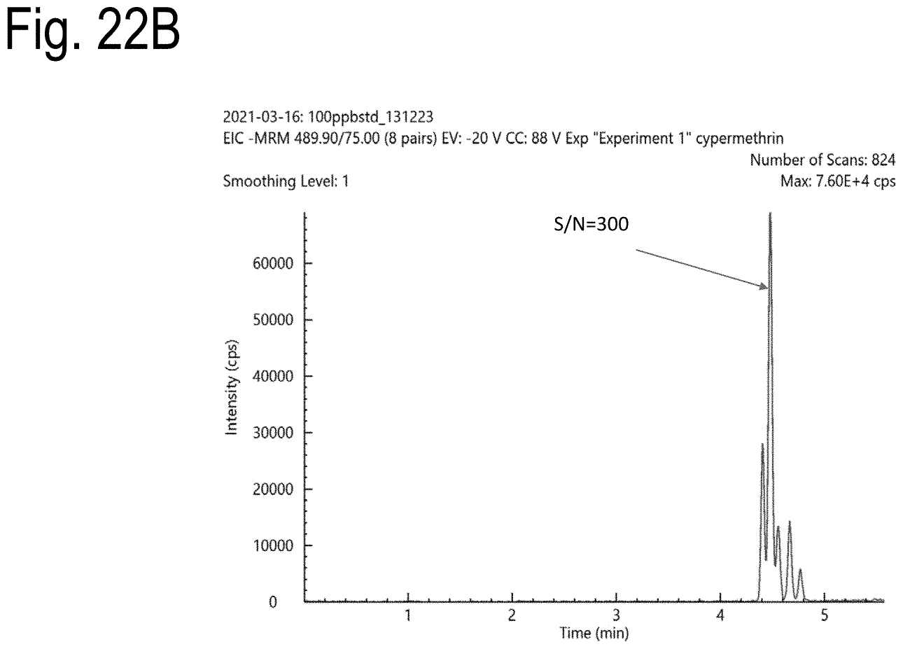

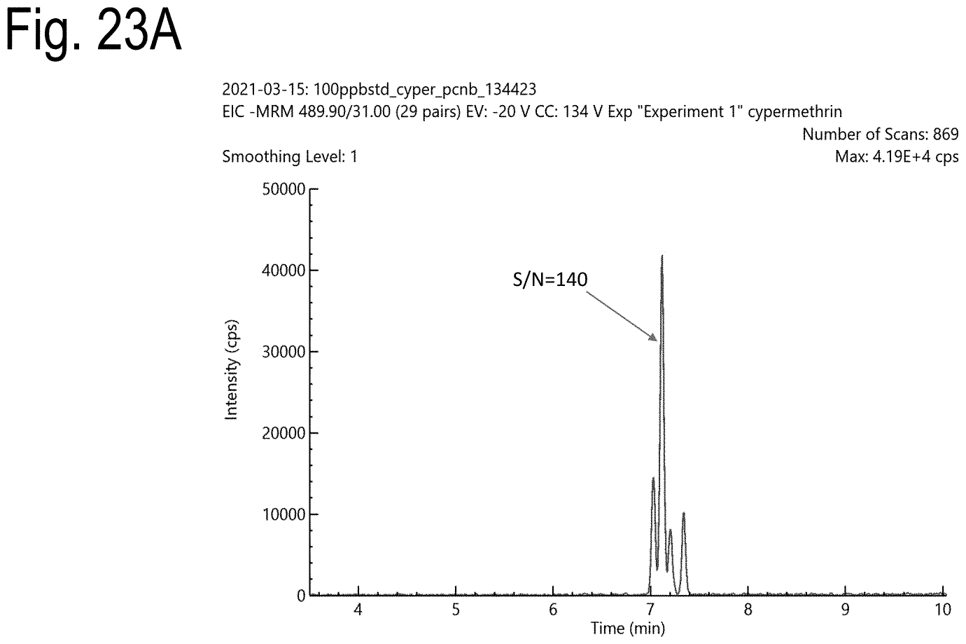

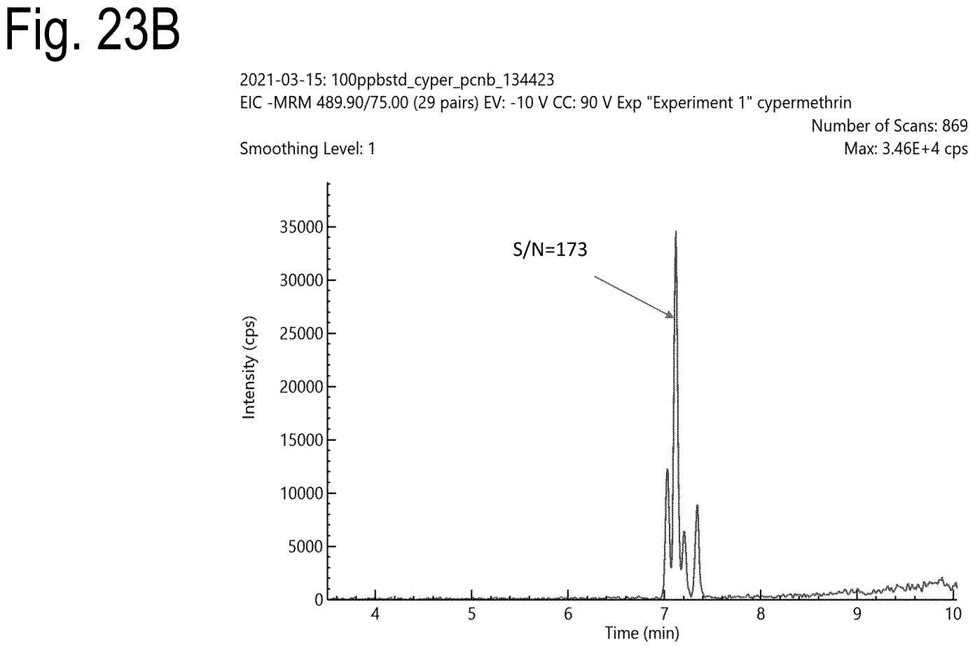

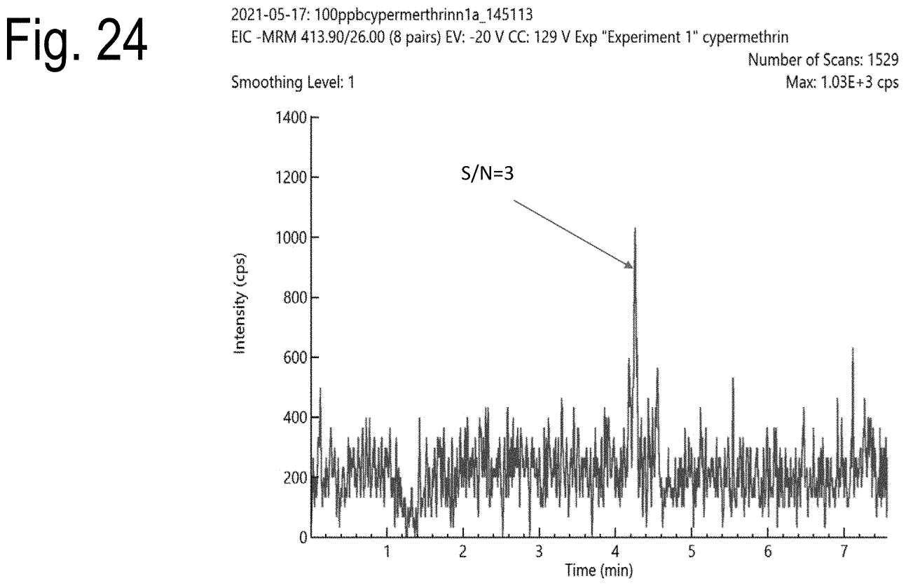

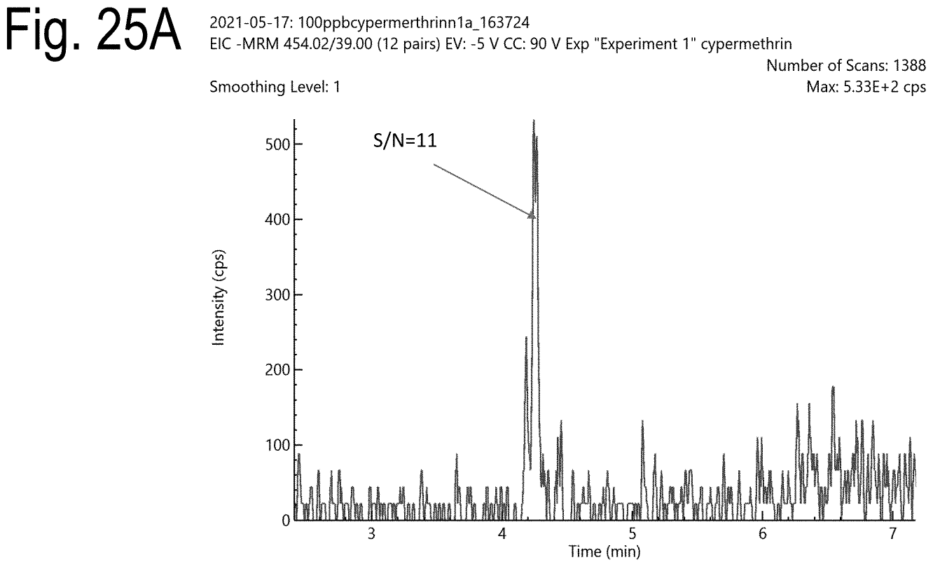

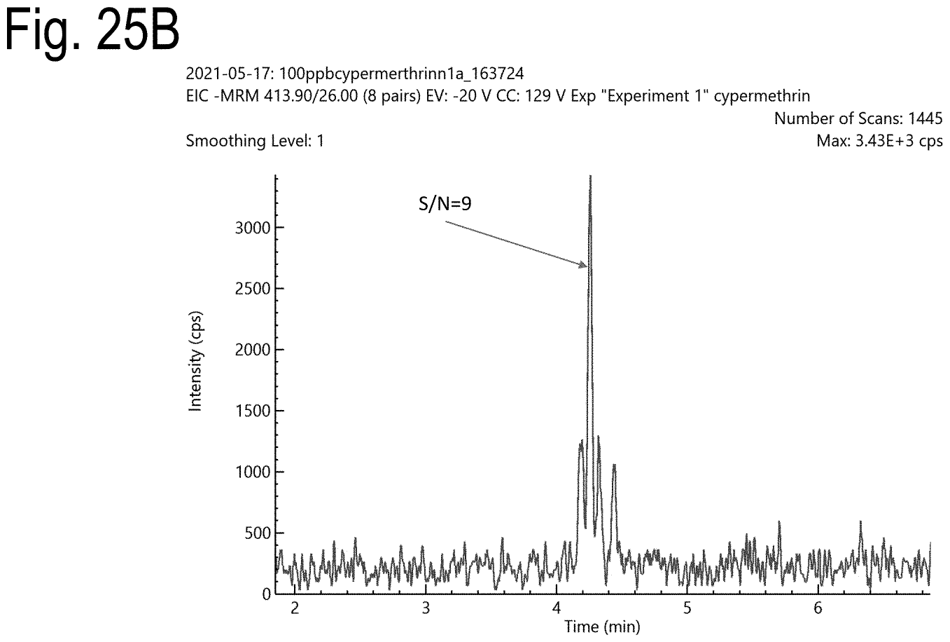

FIGS. 21A and 21B show a 20-fold improvement in the signal for cypermethrin with ammonium hydroxide as an additive. FIGS. 22A and 22B show S/N ratios of 240 and 300, respectively, with ammonium hydroxide as an additive. Using ammonium bicarbonate as the additive reduced the signal intensity and the S/N ratios (FIGS. 23A and 23B). The signal intensity and S/N ratios were also reduced using ammonium formate (FIG. 24) or ammonium fluoride (FIGS. 25A and 25B).

Cyhalothrin

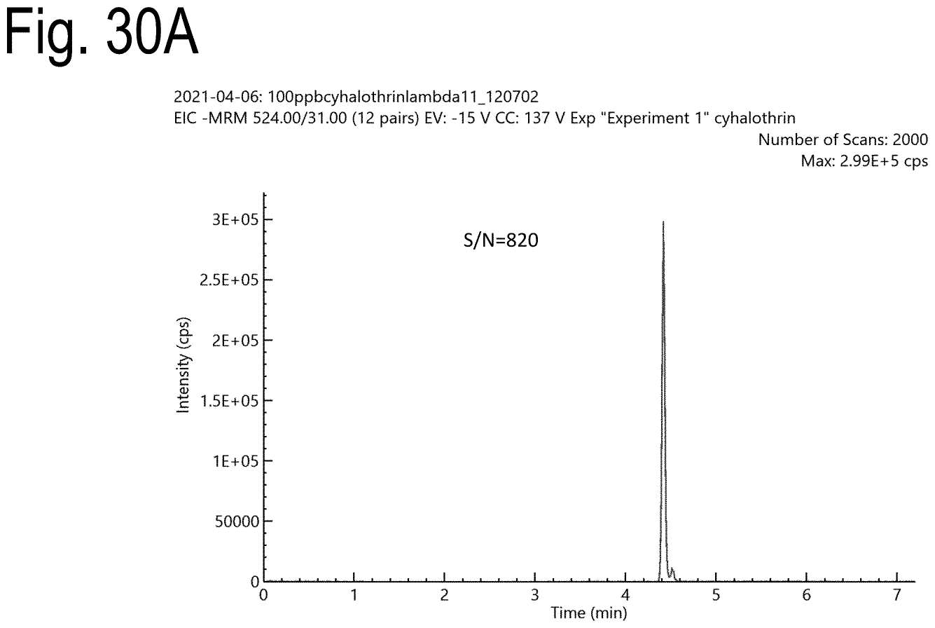

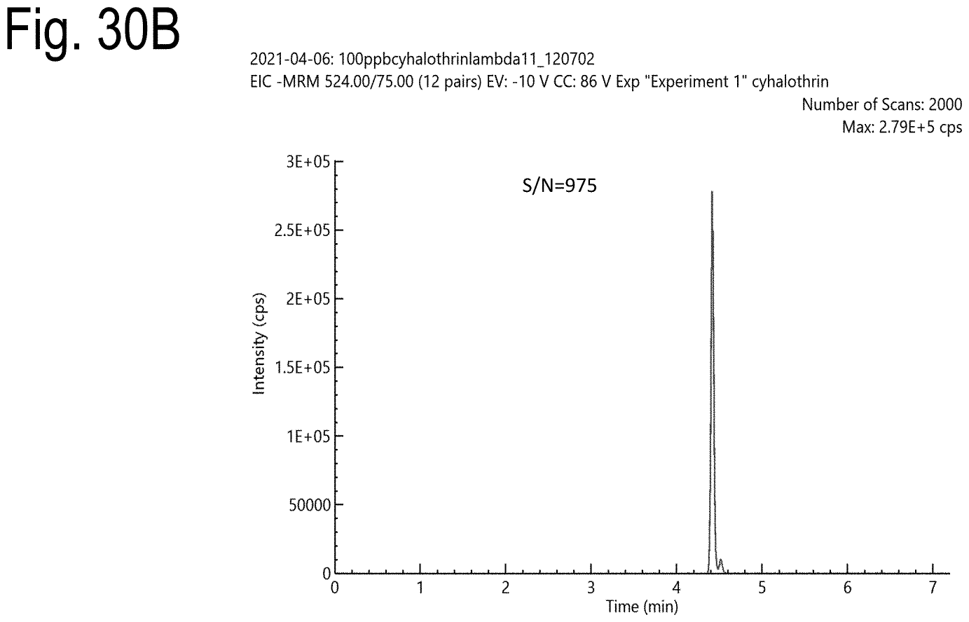

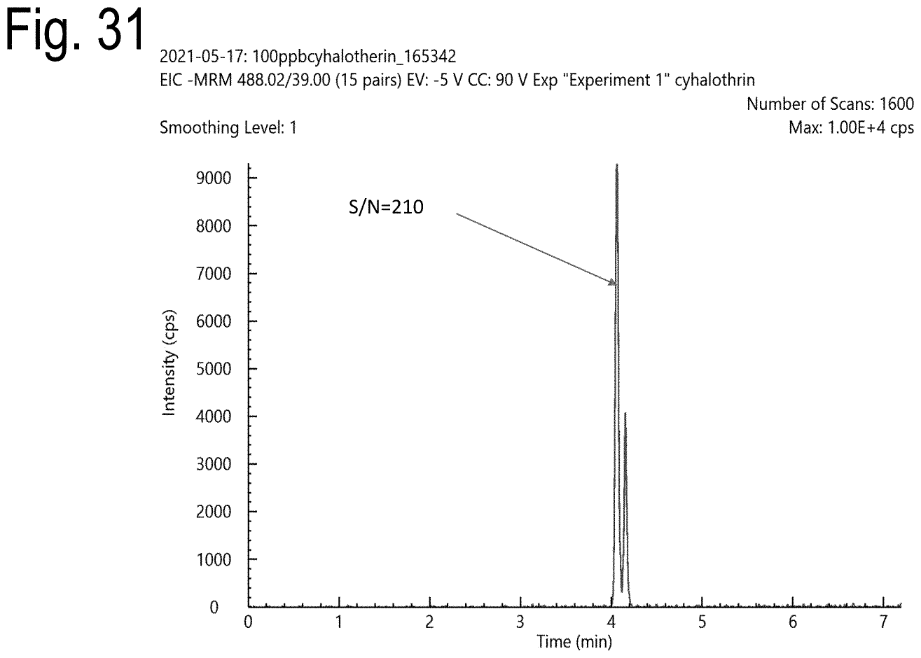

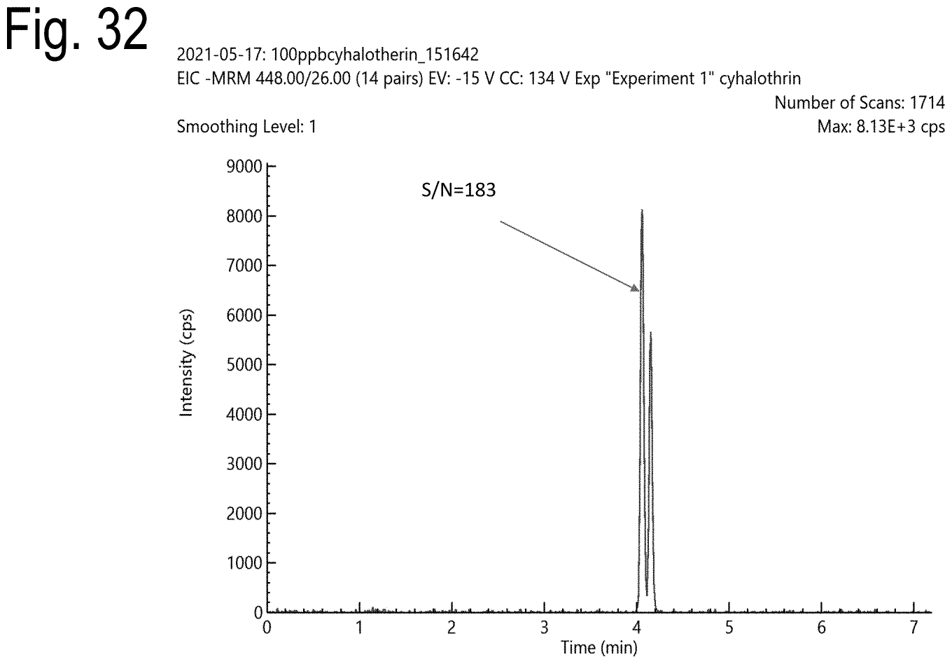

FIGS. 30A and 30B show the signal for cyhalothrin using ammonium hydroxide as an additive. FIGS. 30A and 30B show S/N ratios of 820 and 975, respectively. Using ammonium fluoride (FIG. 31) or ammonium formate (FIG. 32) as additives, the S/N ratios were 210 and 183, respectively, and the signal intensities were lower.

### EXAMPLE 2

This example compares the signals obtained for several pesticides using an APCI source in negative mode with signals obtained using an ESI in negative ion mode and including a ammonium hydroxide as an ammonium salt. Chromatographic separation, mass spectrometry using an ESI in negative ion mode, and data acquisition and analysis were performed as described in Example 1. For the APCI in negative ion mode, the source temperature was 200° C., the hot surface induced desolvation (HSID™) temperature interface was 250° C. Nebulizing gas (air) was 350 arbitrary units, and drying gas (nitrogen) was 150 arbitrary units. Corona discharge current was −3 μA. The mobile phases were water and methanol with no additive for data collected using APCI source.

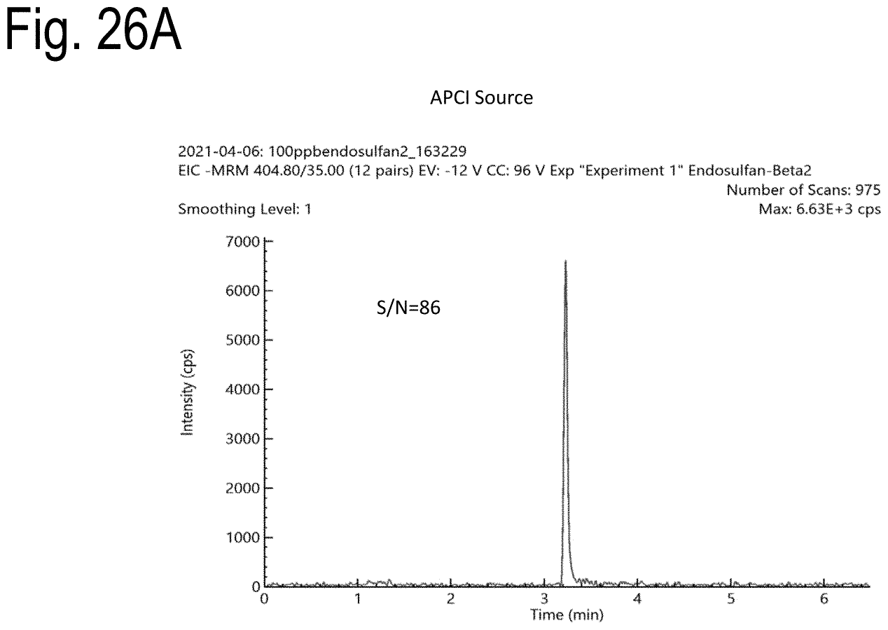

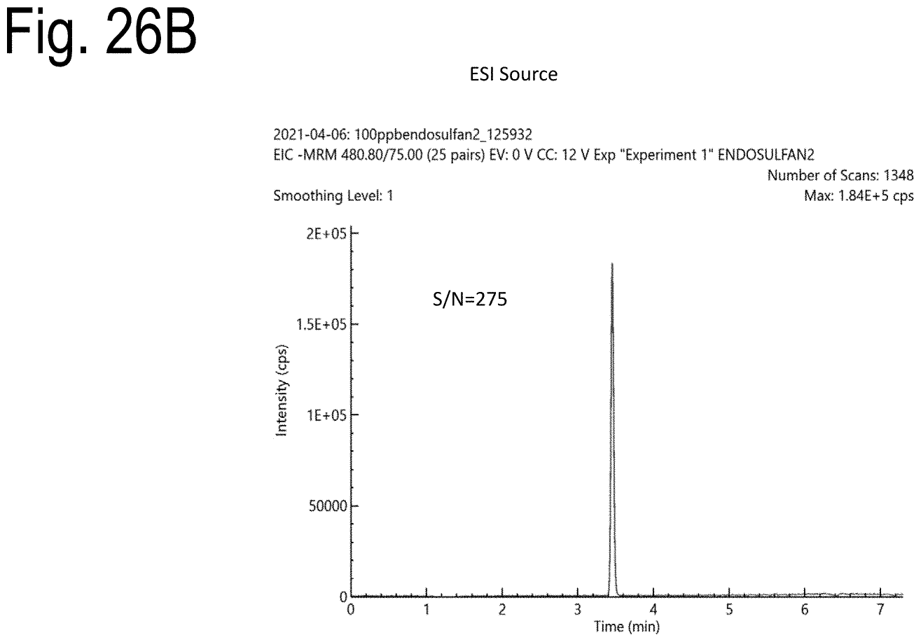

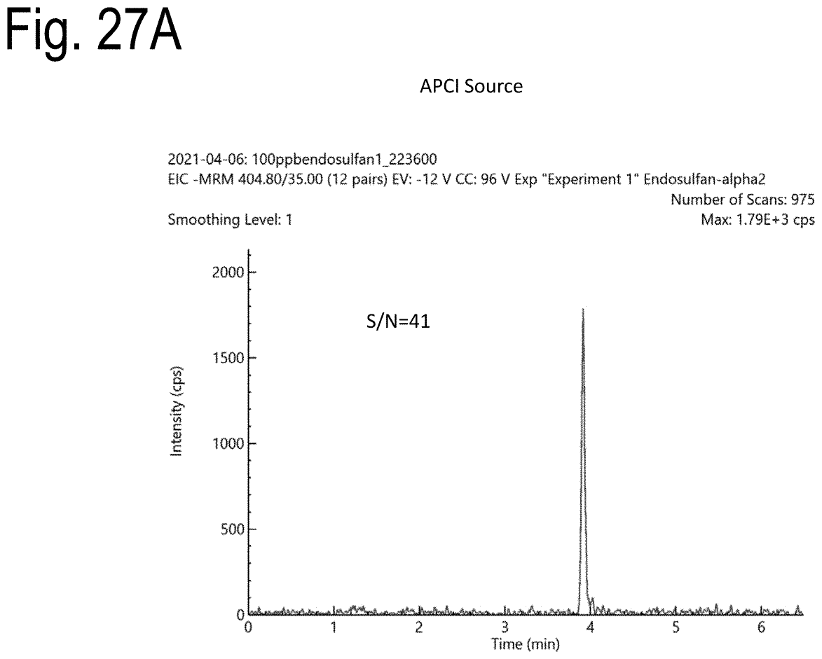

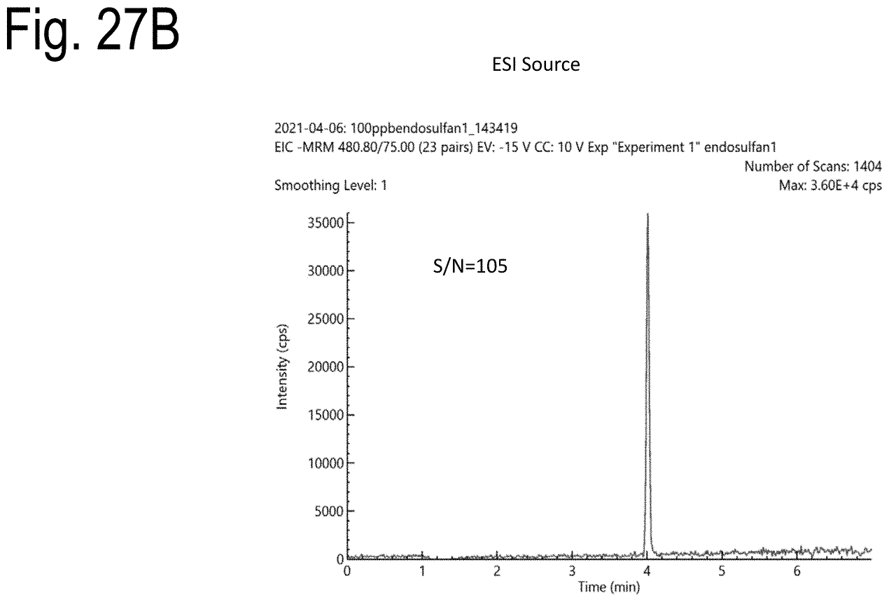

The results for endosulfan 2 are shown in FIGS. 26A (APCI source) and 26B ESI source with ammonium hydroxide). The results for endosulfan 1 are shown in FIGS. 27A (APCI source) and 27B (ESI source with ammonium hydroxide). The LOQs for endosulfan 1 and endosulfan 2 with APCI source were 24.4 and 11.6 ppb, respectively. The LOQs for endosulfan 1 and 2 with ESI source were 9.5 and 3.6 ppb, respectively. In each case, these results demonstrate that using the ESI source in negative mode with ammonium hydroxide as an additive provide results that are 2-3 fold better than the results obtained using the APCI source in negative ion mode.

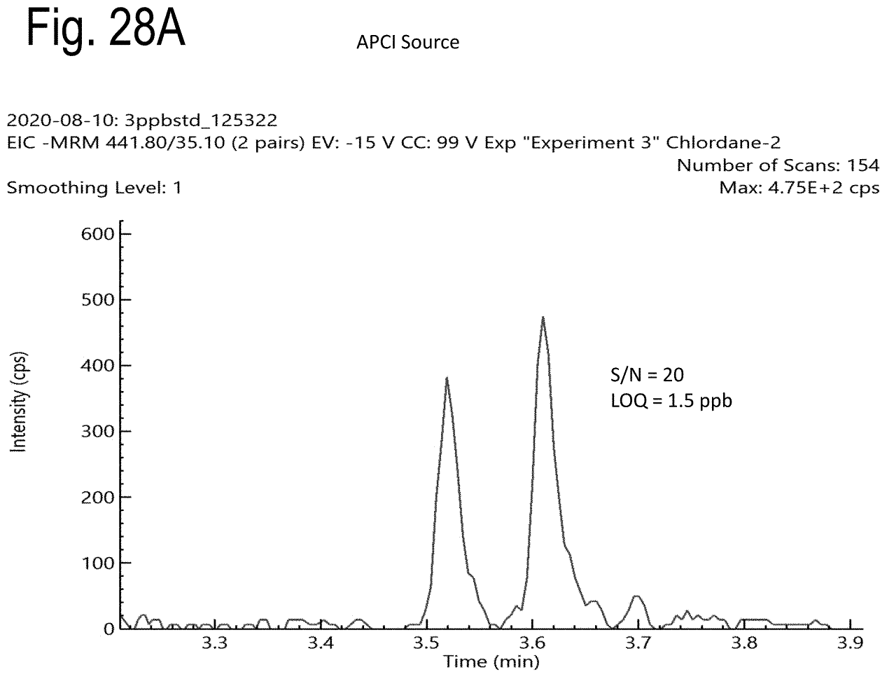

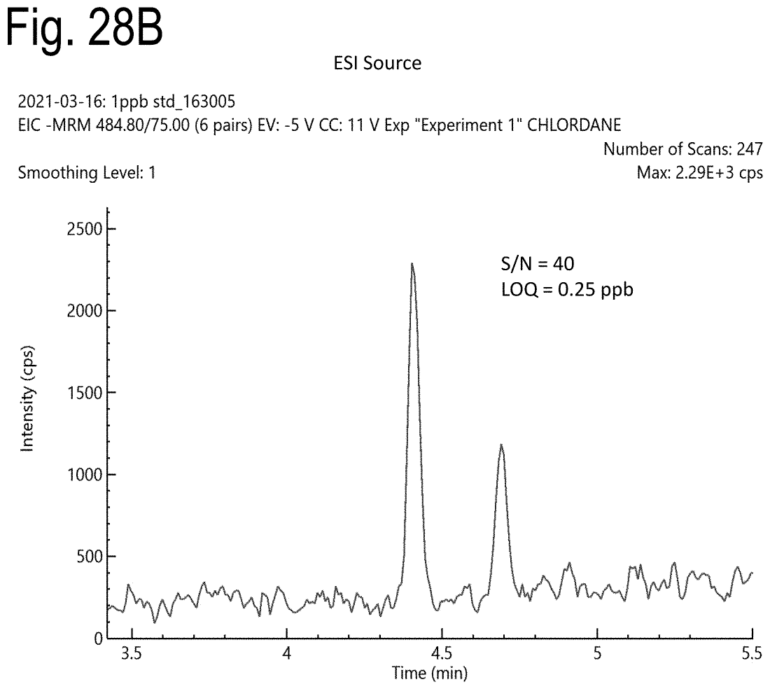

The results for chlordane are shown in FIGS. 28A (APCI source) and 28B (ESI source with ammonium hydroxide). Using the ESI source in negative mode with ammonium hydroxide as an additive, the limit of quantitation was 0.25 ppb.

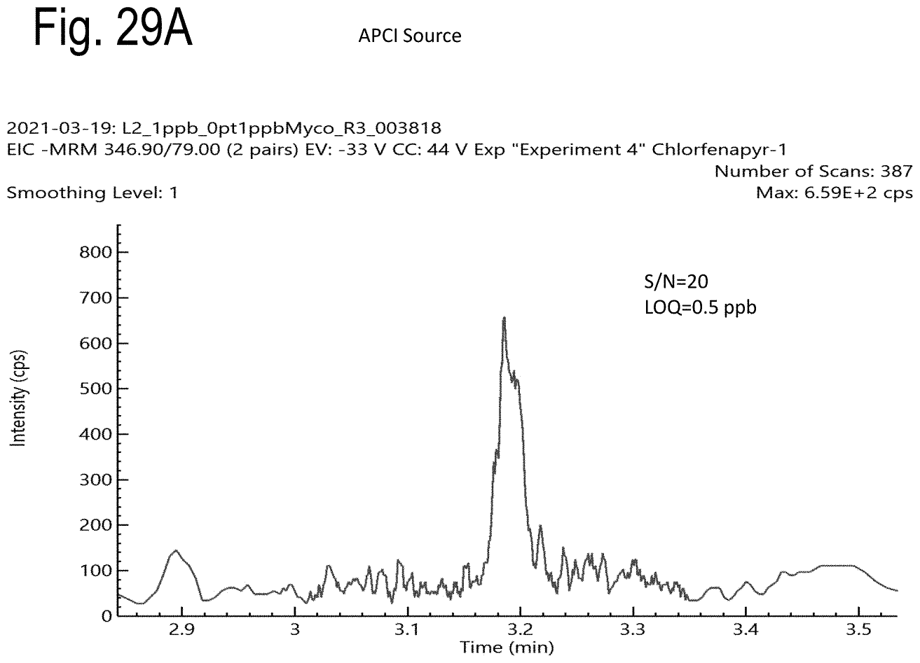

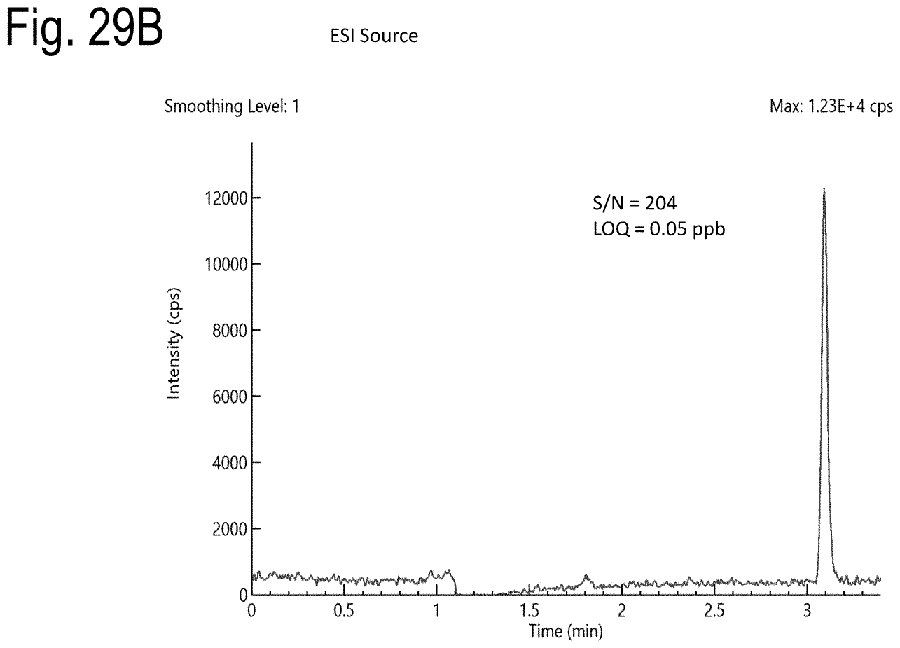

The results for chlorfenapyr are shown in FIG. 29A (APCI source) and 29B (ESI source with ammonium hydroxide). Using the ESI source in negative mode with ammonium hydroxide as an additive, the limit of quantitation was for chlorfenapyr was 0.05 ppb.

### EXAMPLE 3

This example demonstrates the detection sensitivity of pesticides spiked into acetonitrile at a concentration of 5 ppb or 1 ppb, using an ESI source method in negative ion mode and using ammonium hydroxide as an additive.

Chromatographic separation, mass spectrometry, and data acquisition and analysis were performed as described in Example 1.

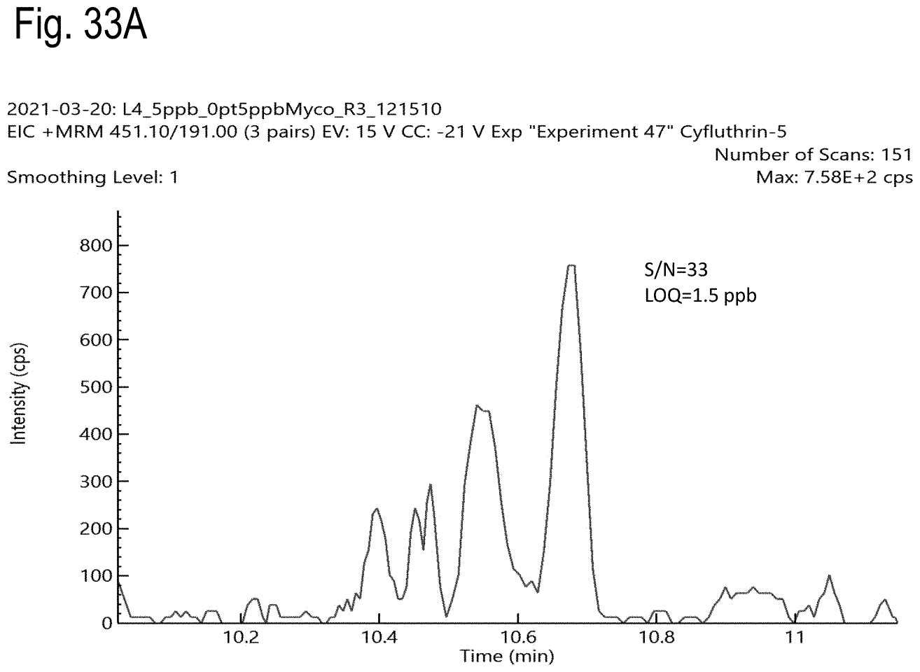

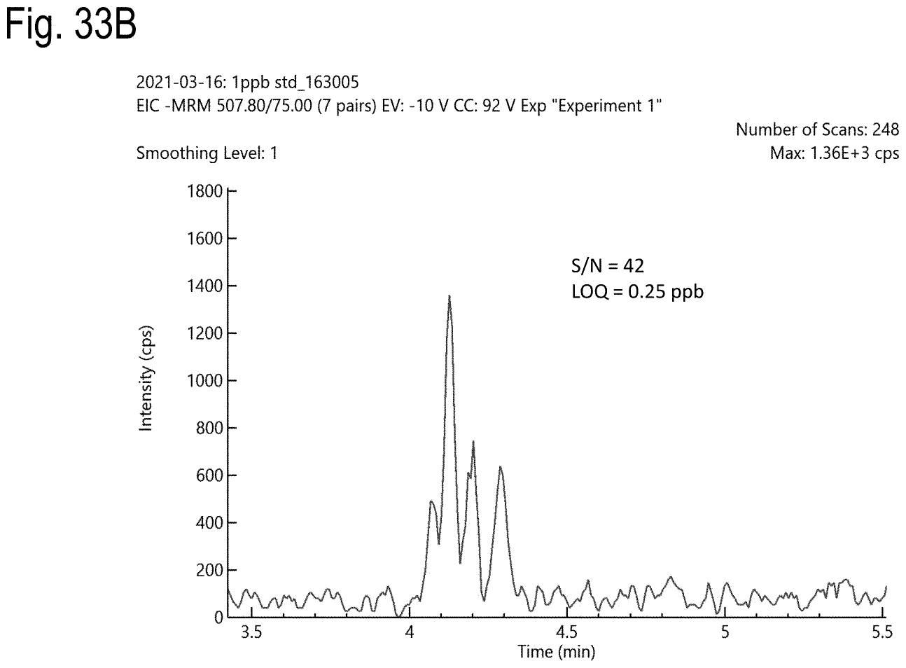

FIG. 33A shows a S/N ratio of 33 and a limit of quantitation of 1.5 ppb for cyfluthrin, spiked into acetonitrile at a concentration of 5 ppb. FIG. 33B shows an S/N ratio and a limit of quantitation of 0.25 ppb for cyfluthrin, spiked into acetonitrile at a concentration of 1 ppb.

FIG. 28B shows an S/N ratio of 40 and an LOQ of 0.25 ppb for chlordane, spiked into acetonitrile at a concentration of 1 ppb.

FIG. 29B shows an S/N ratio of 204 and an LOQ of 0.05 ppb for chlorfenapyr spiked into acetonitrile at a concentration of 1 ppb.

The present technology has been described herein with reference to the accompanying drawings, in which illustrative embodiments of the technology are shown. In the drawings, the relative sizes of regions or features may be exaggerated for clarity or shown schematically. As may be recognized by those of ordinary skill in the pertinent art based on the teachings herein, numerous changes may be made to the above-described and other embodiments of the present invention without departing from the scope of the invention. For example, the method, system, and/or column may be used to detect low levels of pesticides and/or mycotoxins in various matrices, such as, but not limited to, food or water. In addition, the devices, systems, and/or methods may include fewer or more components or features than the embodiments described herein. Thus, this technology may be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, concentrations, and/or phases, these elements, components, concentrations, and/or phases should not be limited by these terms. These terms are only used to distinguish one element, component, concentration, or phase from another element, component, concentration, or phase. Thus, a first element, component, concentration, or phase discussed below could be termed a second element, component, concentration, or phase without departing from the teachings of the present technology.

As used herein, the singular forms “a,” “an,” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth, but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A liquid chromatography (LC) column comprising a mobile phase composition, wherein the mobile phase composition comprises a first mobile phase, a second mobile phase, and from 0.1 mM to 100 mM of an ammonium salt selected from the group consisting of ammonium hydroxide, ammonium bicarbonate, and ammonium fluoride.

2. The LC column of claim 1, wherein the first mobile phase is water.

3. The LC column of claim 1, wherein the second mobile phase is methanol.

4. The LC column of claim 1, wherein the first mobile phase independently comprises a first concentration of the ammonium salt of from 0 mM to 100 mM and the second mobile phase independently comprises a second concentration of the ammonium salt of from 0 mM to 100 mM, provided that at least one of the first and second concentrations is greater than 0 mM.

5. The LC column of laim 1, wherein the mobile phase composition comprises a test sample.

6. The LC column of claim 5, wherein the test sample is a botanical test sample, an environmental sample, or a clinical sample.

7. The LC column of claim 5, wherein the test sample is an extract of a marijuana or hemp product.

8. The LC column of claim 7, wherein the marijuana or hemp product is selected from the group consisting of flowers, concentrates, edibles, topicals, and smokables.

9. The LC column of claim 5, wherein the test sample comprises a pesticide.

10. The LC column of claim 9, wherein the pesticide is selected from the group consisting of chlordane, chlorfenapyr, cyfluthrin, cyhalothrin, cypermethrin, endosulfan 1, and endosulfan 2.

11. A liquid chromatography (LC) separation system, comprising:
(a) an LC column;
(b) a first mobile phase comprising a first concentration of an ammonium salt of from 0 mM to 100 mM; and
(c) a second mobile phase independently comprising a second concentration of from 0 mM to 100 mM of the ammonium salt,
provided that at least one of the first and second concentrations is greater than 0 mM, wherein the ammonium salt is selected from the group consisting of ammonium hydroxide, ammonium bicarbonate, and ammonium fluoride.

12. The LC separation system of claim 11, wherein the first mobile phase comprises water.

13. The LC separation system of claim 11, wherein the second mobile phase comprises methanol.

14. The LC separation system of claim 11, wherein the first and second concentrations of the ammonium salt combined are from 0.1 to 100 mM.

15. A liquid chromatography tandem mass spectrometer (LC-MS/MS) system, comprising:
(a) a liquid chromatography (LC) column comprising a mobile phase composition, wherein the mobile phase composition comprises a first mobile phase, a second mobile phase, and from 0.1 mM to 100 mM of an ammonium salt selected from the group consisting of ammonium hydroxide, ammonium bicarbonate, and ammonium fluoride or the LC separation system of claim 11; and
(b) a triple quadrupole mass spectrometer.

16. The LC-MS/MS system of claim 15, wherein the triple quadrupole mass spectrometer is configured to detect an MRM transition selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524. 00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).

17. A method of detecting a pesticide in a test sample, comprising:
(a) processing a test sample using a liquid chromatography (LC) column comprising a mobile phase composition, wherein the mobile phase composition comprises a first mobile phase, a second mobile phase, and from 0.1 mM to 100 mM of an ammonium salt selected from the group consisting of ammonium hydroxide, ammonium bicarbonate, and ammonium fluoride or the LC separation system of claim 11 to provide an LC column eluant; and
(b) analyzing the LC column eluant for the presence of the pesticide using a triple quadrupole mass spectrometer.

18. A method of detecting a pesticide in a test sample, comprising:
(a) processing a test sample using a liquid chromatography column to produce a first liquid chromatography (LC) column eluant;
(b) adding to the first LC column eluant an ammonium salt selected from the group consisting of ammonium hydroxide, ammonium bicarbonate, and ammonium fluoride to form a second LC column eluant comprising from 0.1 mM to 100 mM of the ammonium salt; and
(c) analyzing the second LC column eluant for the presence of the pesticide using a triple quadrupole mass spectrometer.

19. The method of claim 18, wherein the second LC column eluant comprises the ammonium salt at a concentration of 0.25 to 1.25 mM.

20. The method of claim 18, wherein the test sample comprises a pesticide.

21. The method of claim 20, wherein the pesticide is selected from the group consisting of chlordane, chlorfenapyr, cyfluthrin, cyhalothrin, cypermethrin, endosulfan 1, and endosulfan 2.

22. The method of claim 18, wherein the test sample is a botanical test sample, an aqueous sample, or a clinical sample.

23. The method of claim 18, wherein the test sample is an extract of a marijuana or hemp product.

24. The method of claim 23, wherein the marijuana or hemp product is selected from the group consisting of flowers, concentrates, edibles, topicals, and smokables.

25. The method of claim 18, wherein mass spectrometer is configured to detect an MRM transition selected from the group consisting of 484.80/31.00, 484.80/75.00, and 446.80/39.00 (chlordane); 482.80/31.00, 482.80/75.00, and 446.75/39.03 (chlorfenapyr); 507.80/75.00, 507.80/31.00, and 472.00/39.00 (cyfluthrin); 524. 00/31, 524.00/75.00, and 488.02/39.00 (cyhalothrin); 489.90/31.00, 489.90/75.00, 454.02/39.00, and 413.90/26.00 (cypermethrin); 480.80/75.00 (endosulfan 2); and 480.80/75.00 (endosulfan 1).
